(19) United States
(12) Patent Application Publication
(10) Pub. No.: US 2025/0289384 A1
(43) Pub. Date: Sep. 18, 2025

(54) SYSTEMS AND METHODS FOR INSTRUMENT CLUSTER CONTROL AND DIAGNOSIS THEREOF

(71) Applicant: Holley Performance Products, Inc., Bowling Green, KY (US)

(72) Inventors: John McLeod, Boyne City, MI (US); Tony Pitman, Pleasant View, UT (US); James Coats, Pompano Beach, FL (US)

(21) Appl. No.: 19/078,966

(22) Filed: Mar. 13, 2025

Related U.S. Application Data
(60) Provisional application No. 63/565,872, filed on Mar. 15, 2024.

(51) Int. Cl. B60R 16/023; G07C 5/00; G07C 5/08

(52) U.S. Cl. CPC B60R 16/0232; G07C 5/008; G07C 5/0808

(57) ABSTRACT

Embodiments herein are directed to a communication system for a plurality of instrument gauges of a vehicle. A control module is communicatively coupled to the vehicle and configured to query the vehicle to determine a plurality of parameters associated with the vehicle to use as inputs for the plurality of instrument gauges, determine which type of instrument gauges are present, determine a type of command input provided by the vehicle for each instrument gauge, and output a plurality of data. The control module is further configured to receive a diagnostic command for type of the instrument gauge and in response to receiving the diagnostic command, provide a command data to the corresponding instrument gauge of the plurality of instrument gauges of the vehicle to cause the corresponding instrument gauge to receive a programming instruction, perform a sweep test to determine functionality, or perform a cycle of the corresponding instrument gauge.

### INCORPORATION BY REFERENCE

Any and all applications for which a foreign or domestic priority claim is identified in the Application Data Sheet as filed with the present application are hereby incorporated by reference herein and made a part of the present disclosure.

### TECHNICAL FIELD

The present specification generally relates to communication systems for vehicle instrument clusters and, more specifically, to communication systems for diagnosis of the instrument clusters.

### BACKGROUND

Vehicles equipped with classic instrument clusters require external communication modules to perform testing and diagnosis. However, conventional communication modules only communicate with speedometers and tachometers. Accordingly, a need exists for an external communication module to communicate with all instrument gauges.

### SUMMARY

In one embodiment, a communication system for a plurality of instrument gauges of a vehicle is provided. The communication system includes a control module communicatively coupled to the vehicle. The control module is configured to query the vehicle to determine a plurality of parameters associated with the vehicle to use as inputs for the plurality of instrument gauges, determine which type of instrument gauges of the plurality of instrument gauges are present in the vehicle, determine a type of command input provided by the vehicle and received by each instrument gauge of the plurality of instrument gauges, and output a plurality of display data, the plurality of display data includes the plurality of parameters, the type of instrument gauges of the plurality of instrument gauges present, and the type of command input for each of the plurality of gauge instruments present. The control module is further configured to receive a diagnostic command for type of the instrument gauge and in response to receiving the diagnostic command, provide a command data to the corresponding instrument gauge of the plurality of instrument gauges of the vehicle via the determined type of command input, the command data causes the corresponding instrument gauge to receive a programming instruction, perform a sweep test to determine functionality, or perform a cycle of the corresponding instrument gauge.

In another embodiment, a method for driving a plurality of instrument gauges of a vehicle is provided. The method includes querying, by a control module, the vehicle to determine a plurality of parameters associated with the vehicle to use as inputs for the plurality of instrument gauges, determining, by the control module, which type of instrument gauges of the plurality of instrument gauges are present in the vehicle, determining, by the control module, a type of command input provided by the vehicle and received by each instrument gauge of the plurality of instrument gauges and outputting, by the control module, a plurality of display data, the plurality of display data includes the plurality of parameters, the type of instrument gauges of the plurality of instrument gauges present, and the type of command input for each of the plurality of gauge instruments present. The method continues by receiving, by a mobile device, the plurality of display data, displaying, by the mobile device, a virtual gauge for each of the plurality of instrument gauges present in the vehicle, receiving, by the mobile device, a selection for an input source associated with one or more of the virtual gauge, receiving, by the mobile device, a diagnostic choice for the type of instrument gauges, transmitting, by the mobile device, a diagnostic command to the control module for the corresponding instrument gauge of the plurality of instrument gauges of the vehicle, and in response to receiving the diagnostic command, providing, by the control module, a command data to the corresponding instrument gauge of the plurality of instrument gauges of the vehicle via the determined type of command input, the command data causes the corresponding instrument gauge to receive a programming instruction, perform a sweep test to determine functionality, or perform a cycle of the corresponding instrument gauge.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a top down view of the vehicle including components of a vehicle diagnosis communication system according to one or more embodiments shown and described herein;

FIG. 2 schematically depicts an illustrative wiring arrangement of the vehicle of FIG. 1 according to one or more embodiments shown and described herein;

FIG. 3A schematically depicts illustrative hardware components of a control module that may be used in the vehicle diagnosis communication system according to one or more embodiments shown and described herein;

FIG. 3B schematically depicts an illustrative memory component containing illustrative logic components according to one or more embodiments shown and described herein;

FIG. 3C schematically depicts an illustrative data storage device containing illustrative data components according to one or more embodiments shown and described herein;

FIG. 4A schematically depicts an example wiring arrangement to communicatively couple the control module of FIG. 3A to a speedometer gauge of the vehicle of FIG. 1 according to one or more embodiments shown and described herein;

FIG. 4B schematically depicts an example wiring arrangement to communicatively couple the control module of FIG. 3A to a fuel gauge, a temperature gauge, and an oil pressure gauge of the vehicle of FIG. 1 according to one or more embodiments shown and described herein;

FIG. 4C schematically depicts an example wiring arrangement to communicatively couple the control module of FIG. 3A to a tachometer gauge of the vehicle of FIG. 1 according to one or more embodiments shown and described herein;

FIG. 4D schematically depicts an example wiring arrangement to communicatively couple the control module of FIG. 3A to a boost and pressure gauge of the vehicle of FIG. 1 according to one or more embodiments shown and described herein;

FIG. 4E schematically depicts an example wiring arrangement to communicatively couple the control module of FIG. 3A to each of a plurality of instrument gauges via a gauge harness of the vehicle of FIG. 1 according to one or more embodiments shown and described herein;

FIG. 5 depicts a flow diagram of an illustrative method for an operation of the control module to drive a plurality of instrument gauges according to one or more embodiments shown and described herein;

FIG. 6 depicts a flow diagram of an illustrative method for an operation of the application of the mobile device to drive the plurality of instrument gauges according to one or more embodiments shown and described herein;

FIG. 7 schematically depicts a plurality of virtual gauges displayed by an application of the mobile device of FIG. 1 according to one or more embodiments shown and described herein;

FIG. 8 schematically depicts a speedometer gauge configuration page displayed by the application of the mobile device of FIG. 1 according to one or more embodiments shown and described herein;

FIG. 9 schematically depicts a tachometer gauge configuration page displayed by the application of the mobile device of FIG. 1 according to one or more embodiments shown and described herein;

FIG. 10 schematically depicts a fuel sender device configuration page displayed by the application of the mobile device of FIG. 1 according to one or more embodiments shown and described herein;

FIG. 11 schematically depicts a further fuel sender device configuration page displayed by the application of the mobile device of FIG. 1 according to one or more embodiments shown and described herein;

FIG. 12 schematically depicts a coolant temperature configuration page displayed by the application of the mobile device of FIG. 1 according to one or more embodiments shown and described herein;

FIG. 13 schematically depicts a further coolant temperature configuration page displayed by the application of the mobile device of FIG. 1 according to one or more embodiments shown and described herein;

FIG. 14 schematically depicts a voltage configuration page displayed by the application of the mobile device of FIG. 1 according to one or more embodiments shown and described herein;

FIG. 15 schematically depicts a settings storage page displayed by the application of the mobile device of FIG. 1 according to one or more embodiments shown and described herein;

FIG. 16 schematically depicts a diagnostics default page displayed by the application of the mobile device of FIG. 1 according to one or more embodiments shown and described herein;

FIG. 17 schematically depicts a speedometer gauge diagnostics page displayed by the application of the mobile device of FIG. 1 according to one or more embodiments shown and described herein;

FIG. 18 schematically depicts an input selection type page displayed by the application of the mobile device of FIG. 1 according to one or more embodiments shown and described herein;

FIG. 19 schematically depicts a tachometer gauge page displayed by the application of the mobile device of FIG. 1 according to one or more embodiments shown and described herein;

FIG. 20 schematically depicts a speedometer gauge page displayed by the application of the mobile device of FIG. 1 according to one or more embodiments shown and described herein;

FIG. 21 schematically depicts a coolant temperature configuration page displayed by the application of the mobile device of FIG. 1 according to one or more embodiments shown and described herein; and

FIG. 22 schematically depicts an oil pressure page displayed by the application of the mobile device of FIG. 1 according to one or more embodiments shown and described herein.

### DETAILED DESCRIPTION

Embodiments described herein are generally directed to a communication system for a plurality of instrument gauges of a vehicle in which the communication system includes a control module communicatively coupled to the vehicle, a data communication cable configured to receive and transmit a plurality of data between the vehicle and the control module, and a mobile device communicatively coupled to the control module. The data communication cable may be configured to communicatively couple either to an aftermarket electronic control unit (ECU) or to the vehicle communication port such as an on-board diagnostic II (OBDII) port. The plurality of instrument gauges include any classic instruments that are analog in a display output to a driver. The control module is configured to determine which instrument gauges are present in the vehicle and which parameters may be obtained from the vehicle and used as inputs to each gauges. For example, each of the instrument gauges may be actuated or driven through proper sender devices when the vehicle does not support an output the driver wants to monitor. As such, the control module determines these parameters and permits a user to use the sender inputs, the aftermarket ECU, or the communication port to generate input signals to each of the determined plurality of gauge instruments present in the vehicle.

As such, the control module disclosed herein improves conventional communication system by permitting the control unit to communicate with all of the instrument gauges, by allowing communication through sender devices, through aftermarket ECU, and through the CAN BUS system of the vehicle via the communication port. Furthermore, the mobile device may include an application that receives the parameters to display each of the instrument gauges present in the vehicle in a virtual display, how each instrument gauge gets its signal, and a plurality of predetermined selections for the user to choose between to provide an action command from the mobile device through the control module and is some input into a respective instrument gauge within the vehicle to achieve some desired output by the instrument gauge within the vehicle. For example, the application of the mobile device may display diagnostics information and selection, displays values received by control module, and allow the user to cycle each of the gauges to predetermined positions to verify correct outputs and wiring.

The phrase “communicatively coupled” is used herein to describe the interconnectivity of various components of the vehicle diagnosis communication system described herein and means that the components are connected either through wires, optical fibers, or wirelessly such that electrical, data, optical, and/or electromagnetic signals may be exchanged between the components. It should be understood that other means of connecting the various components of the system not specifically described herein are included without departing from the scope of the present disclosure.

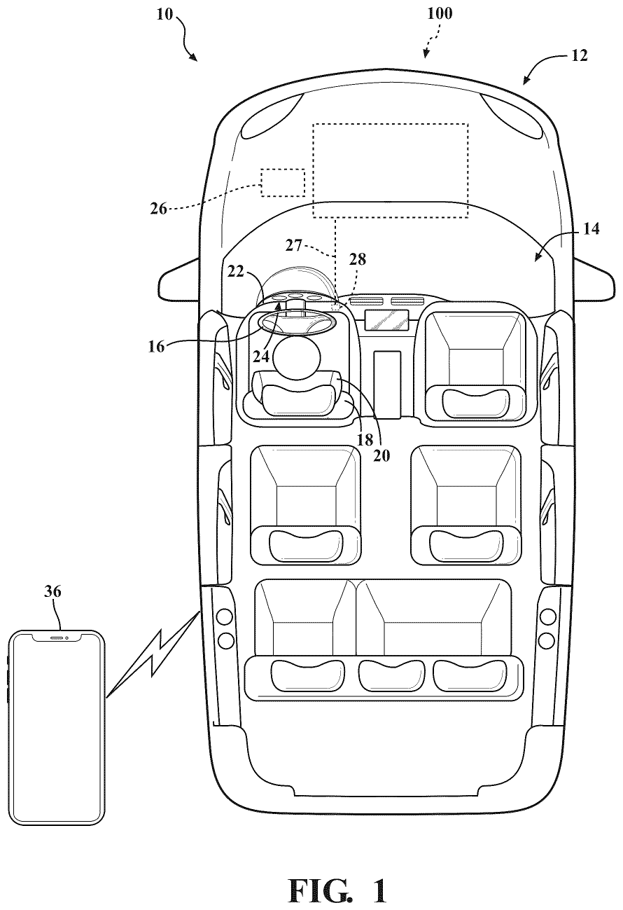

Referring now to the drawings, FIG. 1 schematically depicts a top down view of the vehicle 12 illustrating a partial environmental view of a passenger compartment 14 of the vehicle 12. It should be understood that the vehicle 12 includes a vehicle body onto which a vehicle drivetrain is coupled and the passenger compartment 14 is integral with the vehicle body. The passenger compartment 14 generally defines a passenger cabin of the vehicle 12. The vehicle 12 may further include a steering wheel 16, a driver seat 18, and a driver 20 positioned to be longitudinally spaced apart or extending from an instrument panel 22. Other seats may be present in the passenger compartment 14. Further, the instrument panel 22 may include a plurality of instrument gauges 24. Each of the plurality of instrument gauges 24 may be communicatively coupled to an aftermarket ECU 26, a vehicle CAN BUS system that includes a communication port 28 such as an on-board diagnostic II port, and/or to a specific sender device of a plurality of sender devices 30 to provide signals to each of the plurality of instrument gauges 24. An example aftermarket ECU 26 may include, without limitation, Holley® Dominator, HP, Terminator X, Terminator X Max Sniper and Sniper 2. Each of the instrument gauges of the plurality of instrument gauges 24 may be classic instrument gauges. That is, the output of the gauges is analog for the driver 20 to visualize a movement of a needle to indicate various readings or measurements output for the specific gauge. Example instrument gauges of the plurality of instrument gauges 24 include, without limitation, a speedometer, a tachometer, a fuel level, an oil pressure, a water temperature, a voltmeter, a boost, an air/fuel ratio, an oil temperature, a transmission temperature, and a pyrometer, as discussed in greater detail herein.

The vehicle 12 may generally be any vehicle (e.g., motor vehicle, hybrid, recreational, partial autonomous, off-road, boat, airplane, autonomous, and/or the like) that includes or is capable of being communicatively coupled to various classic instrument gauges and to a control module 32 via a data communication cable 34. The control module 32 may be configured to be communicatively coupled to the aftermarket ECU 26, the communication port 28, and/or to one or more of the plurality of sender devices 30. As such, the data communication cable 34 may be configured to be coupled to the aftermarket ECU 26, the communication port 28, and/or to one or more of the plurality of sender devices 30 for the purpose of receiving and transmitting data between the control module 32 and the aftermarket ECU 26, the communication port 28, and/or one or more of the plurality of sender devices 30 to provide an input to each of the plurality of instrument gauges 24 to diagnose, reset, cycle gauges, and the like, as discussed in greater detail herein.

Further, the control module 32 may be communicatively coupled to a mobile device 36. In some embodiments, the control module 32 may be communicatively coupled to the mobile device 36 via short-range communication protocols such as Bluetooth®. For example, the control module 32 may be configured to use various network hardware to communicatively couple the control module 32 to a mobile device 36, such as a smart phone, a smart pad, a computer, and/or the like, for short range communication between the control module 32 And the mobile device 36, as discussed in greater detail herein. The mobile device 36 may be configured to provide commands to the control module 32, which in turn provides commands to each of the plurality of instrument gauges 24, as discussed in greater detail herein.

In other embodiments, the control module 32 may be communicatively coupled to the mobile device 36 via a computer network, such as, without limitation, a wide area network (WAN), such as the Internet, a local area network (LAN), a mobile communications network, a public service telephone network (PSTN), a personal area network (PAN), a metropolitan area network (MAN), a virtual private network (VPN), and/or another network. As such, the mobile device 36, the control module 32, the data communication cable 34, and the vehicle define a vehicle diagnosis communication system 10.

The mobile device 36 may be configured to include an application that receives parameters to display each of the gauges present in the vehicle in a virtual display, how each gauge gets its signal, and a plurality of predetermined selections for the user to choose between to provide an action command from the mobile device 36 through the control module 32 and is some input into a respective gauge within the vehicle 12 to achieve some desired output by the gauge within the vehicle 12, as discussed in greater detail herein. For example, the application of the mobile device 36 may display diagnostics information and selection, displays values received by control module 32, and allow the user to cycle each of the gauges to predetermined positions to verify correct outputs and wiring, as discussed in greater detail herein.

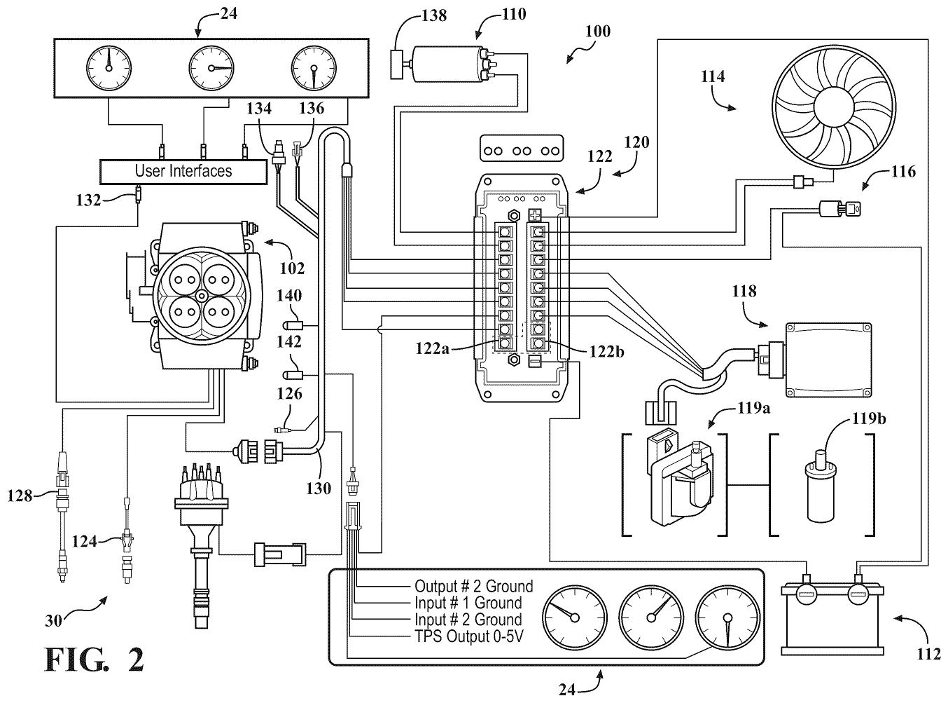

Referring now to FIG. 2, a schematic view of an example wiring arrangement 100. The example wiring arrangement 100 illustrates various portions of vehicle components that may be displayed to the driver via the plurality of instrument gauges 24. In the example wiring arrangement 100, depicted is an a fuel pump 110 which provides fuel to an engine 102, a battery 112 which provides power for starting the engine 102 and which provides power to a power distribution module 120 to power one or more other devices.

The power distribution module 120 may provide a plurality of connections 122. The power distribution module 120 may serve as a junction device that may be located in various locations in order to more easily make the connections for the wiring harness of the engine 102. The power distribution module 120 may be configured to control operation of one or more components, devices, or functional connections. For example, the power distribution module 120 may provide for connection of the main power (positive), ground, and switched ignition for the engine 102. Additionally, for example, the power distribution module 120 may provide for connection of a positive and ground to the fuel pump 110. Still further, the power distribution module 120 may power, ground, and signal wire (points) for an ignition controller 118 and coil 119a and/or spark 119b. Even further in some embodiments, the power distribution module 120 may provide for connection and operation of the engine/radiator cooling fan power, ground, and signal wire.

The power distribution module 120 may be configured to provide a first side of connections 122a and a second side of connections 122b for a plurality of wires routed to the power distribution module 120. The first side 122a may define a first column of connections and the second side 122b may define a second column of connections and each row of two connections are electrically connected and by way of logic programming, and the like, as understood by those skilled in the art.

For example, the power distribution module 120 may include connections for the battery 112, both (+) and (−), a fan 114, a keyed ignition switch 116, a capacitor discharge ignition, a transmission controller, a ground connection, the fuel pump 110, among other devices. This list is not exhaustive and other devices may be connected as appreciated by those skilled in the art.

Additionally illustrated in the example wiring arrangement 100 is the plurality of sender devices 30. Example sender devices of the plurality of sender devices 30 may include, without limitation, a coolant temperature sender device 124, an oil pressure sender device 126, an emission sender device 128, a revolutions per minute sender device 130, a cylinder head temperature device 132, an exhaust gas temperature/pyrometer temperature sender device 134, a transmission temperature sender device 136, a fuel pressure sender device 138, an air/fuel ration sender device 140, a fuel sender device 142, and/or the like. It should be understood that this list is not exhaustive and that there may be more or less sender devices of the plurality of sender devices 30 as appreciated by those with skill in the art.

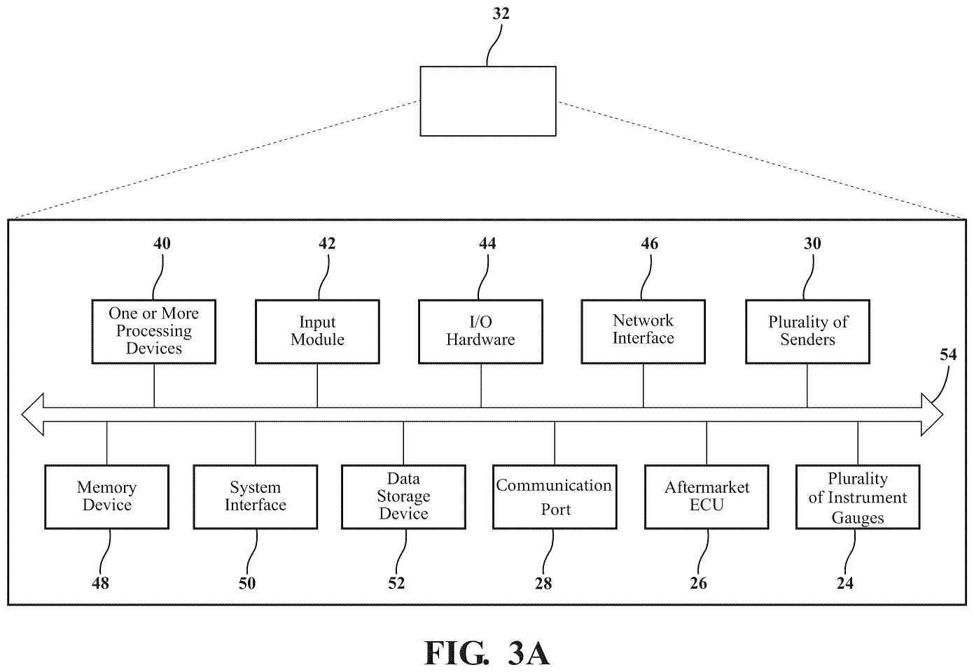

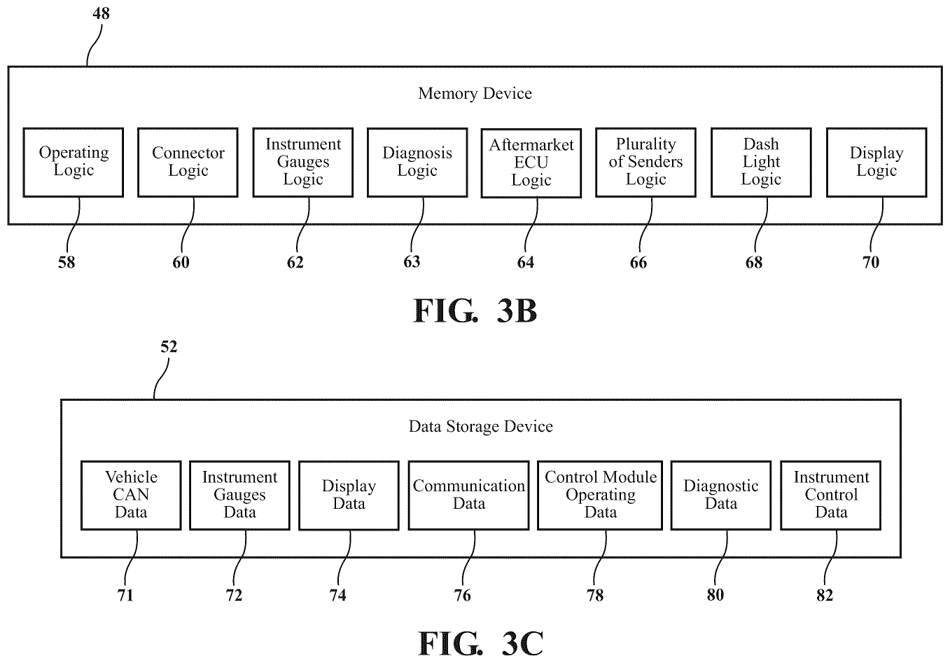

FIG. 3A schematically depicts illustrative hardware components of the control module 32 that may be used in the vehicle diagnosis communication system 10. While the components depicted in FIG. 3A are described with respect to the control module 32, it should be understood that other components may also be used without departing from the scope of the present disclosure.

The control module 32 may include be a central processing unit having a non-transitory computer-readable medium for completing the various processes described herein, embodied as hardware, software, and/or firmware, according to embodiments shown and described herein. While in some embodiments the control module 32 may be configured as a general-purpose computer with the requisite hardware, software, and/or firmware, in other embodiments, the control module 32 may also be configured as a special purpose computer designed specifically for performing the functionality described herein. For example, the control module 32 may be a device that is particularly adapted to automatically determine input parameters for each of the plurality of instrument gauges 24, the number and kind of instrument gauges present, and provide output commands to each of the instrument gauges for the purposes of calibration, diagnosis, initializing a gauge, and the like. In embodiments where the control module 32 is a general-purpose computer, the systems and methods described herein provide a mechanism for improving computer functionality by providing specific output commands desired by the user using alternative parameters for inputs (e.g., the plurality of sender devices 30, aftermarket ECU 26, and/or the communication port 28).

Still referring to FIG. 3A, the control module 32 may generally be external to the onboard vehicle computing system. As also illustrated in FIG. 3A, the control module 32 may include one or more processing devices 40, an input module 42, an I/O hardware 44, a network interface hardware 46, a non-transitory memory device 48, a system interface 50, and the data storage device 52. In some embodiments, the data communication cable 34 may be communicatively coupled to the plurality of sender devices 30, the aftermarket ECU 26, and/or the communication port 28. In other embodiments, the plurality of sender devices 30, the aftermarket ECU 26, and/or the communication port 28 may be directly wired (e.g., without the data communication cable 34) to be communicatively coupled to the control module 32 to be releasably coupled to the control module 32, as discussed in greater detail herein. A local interface 54, such as a bus or the like, may interconnect the various components of the control module 32.

The one or more processing devices 40, such as a computer-processing unit (CPU), may be the central processing unit of the control module 32, perform calculations and logic operations to execute a program. The one or more processing devices 40, alone or in conjunction with the other components, is an illustrative processing device, computing device, or combination thereof. The one or more processing devices 40 may include any processing component configured to receive and execute instructions (such as from the data storage device 52 and/or the memory device 48).

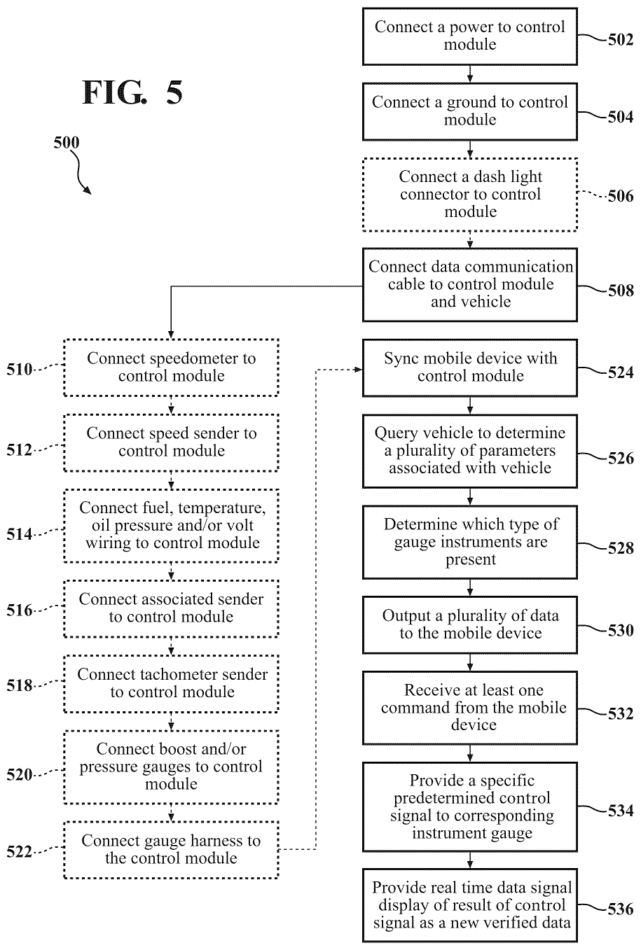

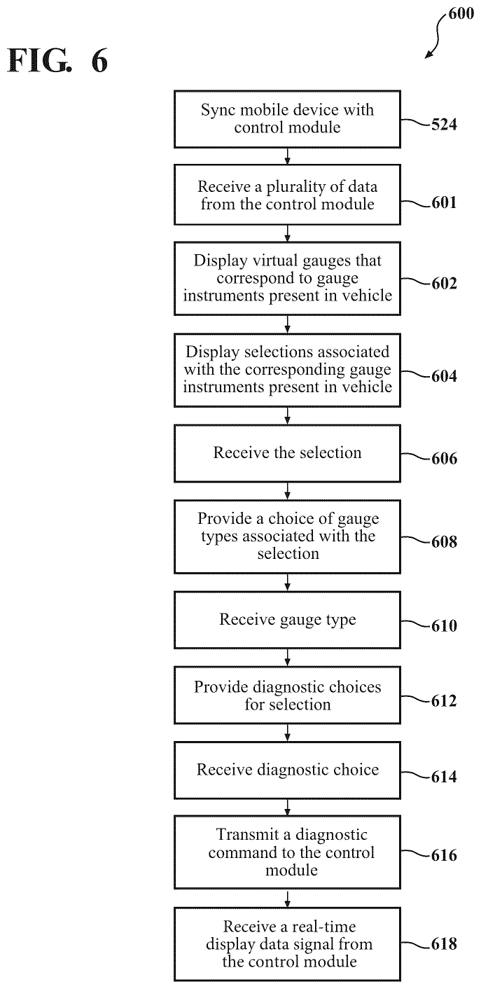

The memory device 48 may be configured as a volatile and/or a nonvolatile computer-readable medium and, as such, may include random access memory (including SRAM, DRAM, and/or other types of random access memory), read only memory (ROM), flash memory, registers, compact discs (CD), digital versatile discs (DVD), and/or other types of storage components. The memory device 48 may include one or more programming instructions thereon that, when executed by the one or more processing devices 40, cause the one or more processing devices 40 to complete various processes, such as the processes described herein with respect to FIGS. 5-6. Still referring to FIG. 3A, the programming instructions stored on the memory device 48 may be embodied as a plurality of software logic modules, where each logic module provides programming instructions for completing one or more tasks, as described in greater detail below with respect to FIG. 3B.

The network interface hardware 46 may include any wired or wireless networking hardware, such as a modem, a LAN port, a wireless fidelity (Wi-Fi) card, WiMax card, mobile communications hardware, and/or other hardware for communicating with other networks and/or devices. For example, the network interface hardware 46 may provide a communications link between the control module 32 and the mobile device 36 depicted in FIG. 1.

Still referring to FIG. 3A, the data storage device 52, which may generally be a storage medium, may contain one or more data repositories for storing data that is received and/or generated. The data storage device 52 may be any physical storage medium, including, but not limited to, a hard disk drive (HDD), memory, removable storage, and/or the like. While the data storage device 52 is depicted as a local device, it should be understood that the data storage device 52 may be a remote storage device, such as, for example, a server-computing device or the like. Illustrative data that may be contained within the data storage device 52 is described below with respect to FIG. 3C.

Still referring to FIG. 3A, the input module 42 may include hardware 38 (i.e. a plurality of connector pins, receiving connectors, wire receivers, or the like) to communicatively couple to the various instruments gauges 24 to the control module 32 for communication between each of the various instruments gauges 24 to the control module 32. That is, the hardware 38 (e.g., a plurality of connector pins, receiving connectors, wire receivers, or the like) may receive wires for ease of connection, as opposed to requiring a soldered connection for each wiring connection. In some embodiments, a button or other electrically coupled input device may be disposed as a power on function such that when the button or other input device is activated (i.e., touched, moved, etc.), the one or more processing devices 40 executes operating logic stored on the memory device 48 to activate the control module 32.

The I/O hardware 44 may communicate information between the local interface 54 and one or more other components of the control module or component communicatively coupled to the control module 32 (e.g., the plurality of sender devices 30, the aftermarket ECU 26, the communication port 28, and the like).

For example, the I/O hardware 44 may act as an interface between the control module 32 and other components, such as the plurality of instrument gauges 24, the plurality of sender devices 30, the aftermarket ECU 26, and the vehicle CAN BUS communication 27 via the communication port 28. In some embodiments, the I/O hardware 44 may be utilized to receive and/or transmit one or more commands to the other components of the such to between the mobile device 36 and components of the vehicle 12 (e.g., the plurality of instrument gauges 24, the plurality of sender devices, 30, the aftermarket ECU 26, and the vehicle CAN BUS communication 27 via the communication port 28).

The network interface hardware 46 may include any wired or wireless networking hardware, such as a modem, a LAN port, a wireless fidelity (Wi-Fi) card, WiMax card, mobile communications hardware, and/or other hardware for communicating with other networks and/or devices. For example, the network interface hardware 46 may provide a communications link between the control module 32 and the mobile device 36 (FIG. 1).

The system interface 50 may generally provide the control module 32 with an ability to interface with one or more external devices such as, for example, onboard computing devices of the vehicle 12, onboard computing device of the mobile device 36, and the like. Communication with external devices may occur using various communication protocols and ports (not shown).

With reference to FIG. 3B, in some embodiments, the program instructions contained on the memory device 48 may be embodied as a plurality of software modules, where each module provides programming instructions for completing one or more tasks. For example, FIG. 3B schematically depicts the memory device 48 containing illustrative logic components according to one or more embodiments shown and described herein. As shown in FIG. 3B, the memory device 48 may be configured to store various processing logic, such as, for example, operating logic 58, connector logic 60, instrument gauges logic 62, diagnosis logic 63, aftermarket ECU logic 64, plurality of sender devices logic 66, dash light logic 68, and display logic 70 (each of which may be embodied as a computer program, firmware, or hardware, as an example). The operating logic 58 may include an operating system and/or other software for managing components of the control module 32 (FIG. 3A). Further, the operating logic 58 may contain one or more software modules for generating data, transmitting data, and/or analyzing data. Additionally, the may contain one or more software modules for determining various status of the control module 32 such as, without limitation, a power of the control module 32, Bluetooth® connectivity, and other data concerning a circuit board of the control module 32 and display such status via illuminating on-board diagnostic lights to give a visual status of the control module 32. It should be understood that the operating logic 58 may work in conjunction with the other illustrative logic components of the memory device 48.

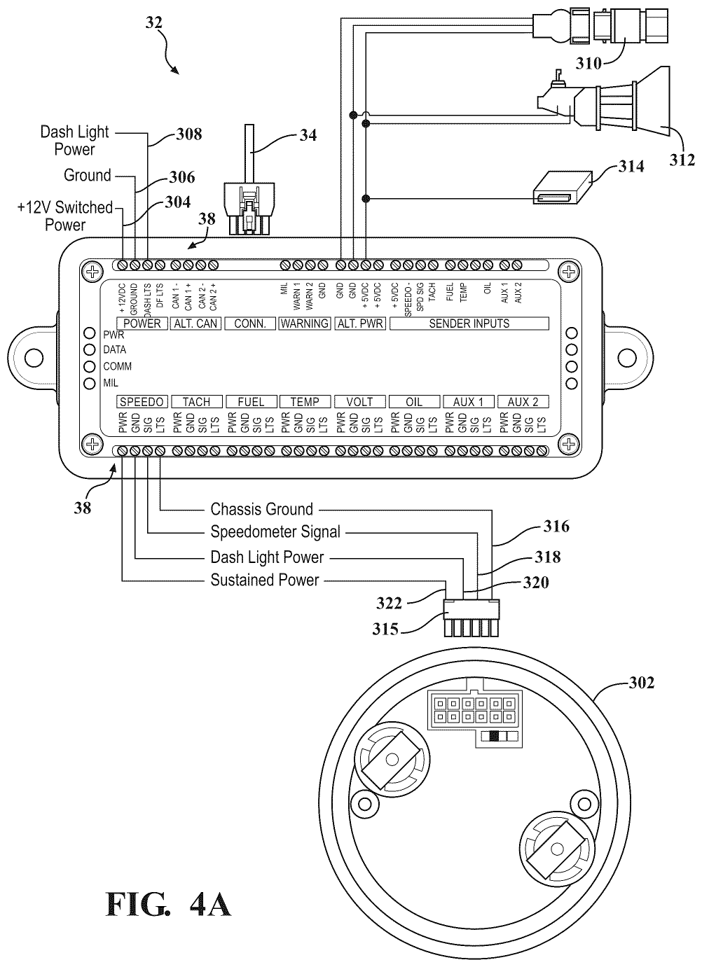

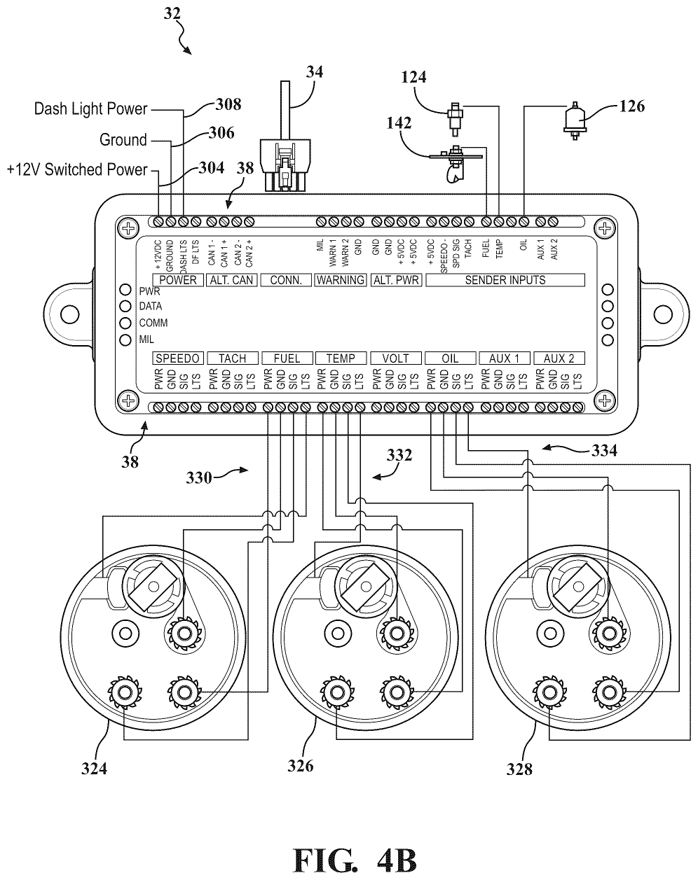

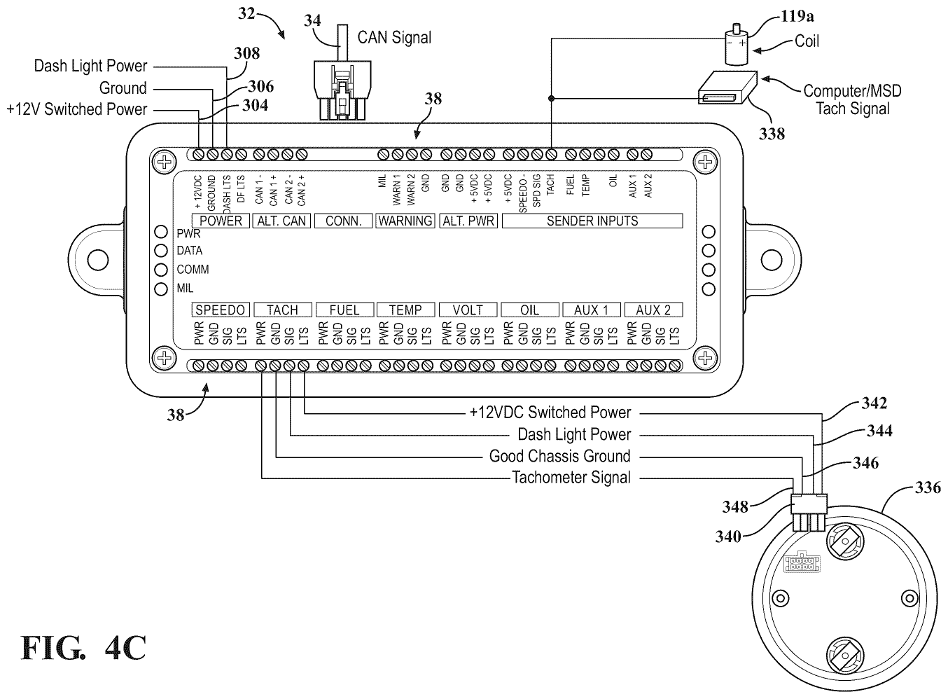

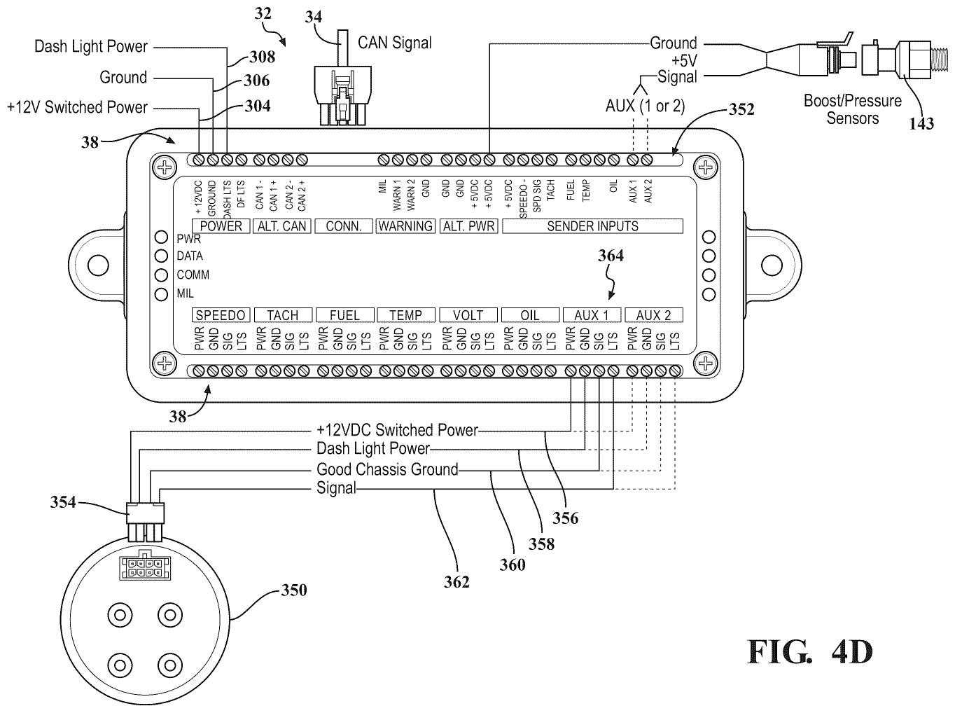

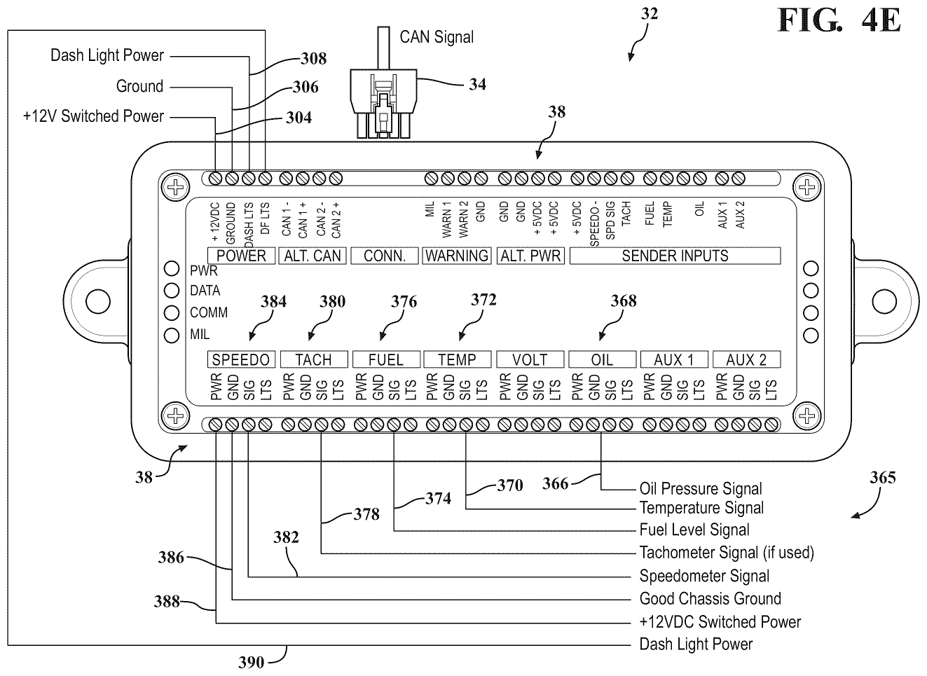

Still referring to FIG. 3B, the connector logic 60 may contain one or more software modules for collecting data from one or more sources of the vehicle 12 via the vehicle CAN BUS communication 27 via the data communication cable 34 as depicted in FIG. 4A. As such, the connector logic 60 may parse through data provided by the vehicle 12 for data related to instrument gauges 24 such as input data sent to the instrument gauges 24 or output data send out by the instrument gauges 24. As such, the connector logic 60 may work in conjunction with the other illustrative logic components of the memory device 48.

The instrument gauges logic 62 may contain one or more software modules for gathering parameters data and other data from the plurality of instrument gauges 24, such as the kind and type of gauges present, the input of each of the gauges (e.g., whether input is from a sender, a vehicle computer via CAN BUS, other communication, and the like), current settings and outputs for each of the plurality of instrument gauges 24, and the like, and provide commands to the plurality of instrument gauges 24 for calibration, diagnosing, sweeping and other actions with the plurality of instrument gauges 24. As such, the instrument gauges logic 62 may work in conjunction with the other illustrative logic components of the memory device 48.

The diagnosis logic 63 may contain one or more software modules for determining specific diagnostic information based on the identified type of instrument gauge 24 present in the vehicle 12 and providing selections to the user via the application of the mobile device 36 to perform certain and specific diagnostics based on the identified type of instrument gauge 24 (e.g., reset, calibrate or do a sweep test on that instrument gauge). As such, the diagnosis logic 63 may work in conjunction with the other illustrative logic components of the memory device 48. The aftermarket ECU logic 64 may contain one or more software modules for collecting data and transmitting data, between one or more sources of the vehicle 12 via the aftermarket ECU 26 via the data communication cable 34 as depicted in FIG. 1. As such, the aftermarket ECU logic 64 may work in conjunction with the other illustrative logic components of the memory device 48.

The plurality of sender devices logic 66 may contain one or more software modules for activating various sender devices and/or receiving data from the various sender devices to control at least one of the plurality of instrument gauges 24. The activation of at least one of the plurality of instrument gauges 24 may be to generate various outputs by the corresponding at least one gauge for calibration purposes, diagnosis purposes, setting a baseline, and the like. The dash light logic 68 may contain one or more software modules for communicating with the vehicle 12 to control the dash lights that illuminate each of the plurality of instrument gauges 24. As such, the plurality of sender devices logic 66 may work in conjunction with the other illustrative logic components of the memory device 48.

The display logic 70 may contain one or more software modules for communicating data with the mobile device 36 for displaying of virtual gauges on the application of the mobile device in real time. As such, the virtual gauges mirror or mimic what should be occurring on the plurality of instrument gauges 24 for the purposes of diagnosis, calibration, and the like, of each of the plurality of instrument gauges 24. Further, the display logic 70 may contain one or more software modules for providing the mobile device with selections for input sources for a respective instrument gauge, if required, diagnosis options via user selections, and various instrument gauge specifics based on the type of instrument gauge (e.g., maximum miles per hour on speedometer, rotation of a needle of a specific gauge, and the like). As such, the display logic 70 may work in conjunction with the other illustrative logic components of the memory device 48.

FIG. 3C schematically depicts a block diagram of various data contained within a storage device (e.g., the data storage device 52). As shown in FIG. 3C, the data storage device 52 may include, for example, vehicle CAN data 71, instrument gauges data 72, display data 74, communication data 76, control module operating data 78, diagnostic data 80, and instrument control data 82. The vehicle CAN data 71 may include data received from the vehicle via the CAN BUS communication system of the vehicle 12 (FIG. 1). The instrument gauges data 72 may include data regarding the type of instruments gauges present (e.g., a speedometer gauge, a tachometer gauge, a fuel level gauge, an oil pressure gauge, a water temperature gauge, a voltmeter gauge, a boost gauge, an air/fuel ratio gauge, an oil temperature gauge, a transmission temperature gauge, a pyrometer gauge, and/or the like), the input type for each of the gauges (e.g., from the aftermarket ECU 26, the plurality of sender devices 30, the vehicle CAN BUS communication 27 via the communication port 28, and the like).

The display data 74 may include data to be displayed by the mobile device such as the type of gauge instruments of the plurality of instrument gauges 24 that are present, the inputs for the plurality of instrument gauges 24, and the data signal for each of the plurality of instrument gauges 24 present. The display data 74 may include real time data from the aftermarket ECU 26, the plurality of sender devices 30, the vehicle CAN BUS communication 27, and the like to be transmitted to the mobile device 36 for calibration, diagnosing, sweeping, and the like, of each of the plurality of instrument gauges 24. The communication data 76 may include data for communication between the control module 32, the mobile device 36 and the vehicle 12 (e.g., the aftermarket ECU 26, the plurality of sender devices 30, the vehicle CAN BUS communication 27). As such, various communication protocols may be stored in the communication data 76 for the purposes of communicatively coupling the control module 32 to other components of the vehicle diagnosis communication system 10.

The control module operating data 78 may include data regarding which of the plurality of instrument gauges 24 are communicatively coupled to the control module 32, which sender devices of the plurality of sender devices are communicatively coupled to the control module 32, pairing information and data with the mobile device 36, and other data necessary to be stored and recalled to perform the functionality described herein. The control module operating data 78 may further include data regarding a power of the control module 32, Bluetooth® connectivity, and other data concerning a circuit board of the control module 32. Such data may be used to illuminate on-board diagnostic lights to give a visual status of the control module 32.

The diagnostic data 80 may include data regarding user selections from the application executable on the mobile device 36. Further, the diagnostic data 80 may include data regarding the various diagnostic capabilities based on the type of instrument gauge, how the gauge receives inputs, and the like. For example, some instrument gauge may only be able to perform a sweep, while others may be subjected to a reset, a calibration, a sweep test on the instrument gauge, and/or the like.

The instrument control data 82 may include data regarding how the various instrument gauges receive inputs and may store the command data (e.g., diagnostic command data, sweep command data, calibration command data, reset command data, and/or the like) to perform some function or action onto at least one of the plurality of instrument gauges 24. As such, the command data may be provided or transmitted to a corresponding gauge instrument of the plurality of instrument gauges 24 of the vehicle 12 via a determined data signal based on how the corresponding gauge receives the input.

It should be understood that the components illustrated in FIGS. 3A-3C are merely illustrative and are not intended to limit the scope of this disclosure. More specifically, while the components in FIGS. 3A-3C are illustrated as residing within the control module 32, this is a non-limiting example. In some embodiments, one or more of the components may reside external to the control module 32 such as within the mobile device 36, within a cloud based platform, and/or the like. As such, other components may include similar hardware, software, and/or firmware to perform the functionality described herein.

Referring now to FIG. 4A, an example wiring arrangement to communicatively couple the control module 32 to a speedometer gauge 302 of the plurality of instrument gauges 24 is schematically depicted. As depicted, the control module 32 is communicatively coupled to the data communication cable 34, which may be coupled to the vehicle 12 via either the aftermarket ECU 26 or the communication port 28. The control module 32 is powered by 12V switched power 304 and ground 306. In some embodiments, a dash light power 308 may also be communicatively coupled to the control module 32. The control module 32 is configured to receive data from the vehicle through the data communication cable 34.

In some embodiments, if data is not received through the data communication cable 34 either because the vehicle 12 is not communicating or the data is not provided by the aftermarket ECU 26 or the vehicle CAN BUS communication 27, in the depicted embodiment, a pulse signal generator 310, a vehicle speed sensor 312, and a computer speed signal 314 may be communicatively coupled to the control module 32 via direly wiring into the hardware 38 of the control module 32 to be releasably coupled to the control module 32. Further, the speedometer gauge 302 may be coupled to a connector 315, which may be communicatively coupled to the hardware 38 of the control module 32 via a chassis ground connection 316, a speedometer signal connection 318, a dash light power connection 320, and a switched power connection 322 to be releasably coupled to the control module 32. As such, the control module 32 may provide and receive data and signals from the speedometer gauge 302 via the data communication cable 34 or the directly wired connections including, without limitation, power to the speedometer gauge 302, dash lights to the speedometer gauge 302, and input commands to control the speedometer gauge 302 such as moving a needle, as discussed in greater detail herein.

Referring now to FIG. 4B, an example wiring arrangement to communicatively couple the control module 32 to a fuel gauge 324, a temperature gauge 326 and an oil pressure gauge 328 of the plurality of instrument gauges 24 is schematically depicted. As depicted, the control module 32 is communicatively coupled to the data communication cable 34, which may be coupled to the vehicle 12 via either the aftermarket ECU 26 or the communication port 28. The control module 32 is powered by the 12V switched power 304 and the ground 306. In some embodiments, the dash light power 308 may also be communicatively coupled to the control module 32. The control module 32 is configured to receive data from the vehicle through the data communication cable 34.

In some embodiments, if data is not received through the data communication cable 34 either because the vehicle 12 is not communicating or the data is not provided by the aftermarket ECU 26 or the vehicle CAN BUS communication 27, in the depicted embodiment, the coolant temperature sender device 124, the fuel sender device 142, and/or the oil pressure sender device 126 may be communicatively coupled to the control module 32 via direct wiring into the hardware 38 of the control module 32 to be releasably coupled to the control module 32. Further, each of the fuel gauge 324, the temperature gauge 326 and the oil pressure gauge 328 may be communicatively coupled to the hardware 38 of the control module 32 via connector inputs 330 for the fuel gauge 324, connector inputs 332 for the temperature gauge 326, and/or connector inputs 334 for the oil pressure gauge 328 to be releasably coupled to the control module 32.

As such, the control module 32 may provide and receive data and signals from the fuel gauge 324, the temperature gauge 326 and the oil pressure gauge 328, respectively, via the data communication cable 34 or the directly wired connections including, without limitation, power to each of the fuel gauge 324, the temperature gauge 326 and the oil pressure gauge 328, dash lights to each of the fuel gauge 324, the temperature gauge 326 and the oil pressure gauge 328, and input commands to control each of the fuel gauge 324, the temperature gauge 326 and the oil pressure gauge 328 such as moving a needle, as discussed in greater detail herein.

Referring now to FIG. 4C, an example wiring arrangement to communicatively couple the control module 32 to a tachometer gauge 336 of the plurality of instrument gauges 24 is schematically depicted. As depicted, the control module 32 is communicatively coupled to the data communication cable 34, which may be coupled to the vehicle 12 via either the aftermarket ECU 26 or the communication port 28. The control module 32 is powered by 12V switched power 304 and ground 306. In some embodiments, the dash light power 308 may also be communicatively coupled to the control module 32. The control module 32 is configured to receive data from the vehicle through the data communication cable 34.

In some embodiments, if data is not received through the data communication cable 34 either because the vehicle 12 is not communicating or the data is not provided by the aftermarket ECU 26 or the vehicle CAN BUS communication 27, in the depicted embodiment, the coil 119a and a computer tach signal 338 may be communicatively coupled to the control module 32 via direct wiring into the hardware 38 of the control module 32. Further, the tachometer gauge 336 may be coupled to a connector 340, which may be communicatively coupled to the hardware 38 of the control module 32 via a switched power connection 342, a dash light power connection 344, a chassis ground connection 346, and a tachometer signal connection 348. As such, the control module 32 may provide and receive data and signals from the tachometer gauge 336 via the data communication cable 34 or the directly wired connections including, without limitation, power to the tachometer gauge 336, dash lights to the tachometer gauge 336, and input commands to control the tachometer gauge 336, such as moving a needle, as discussed in greater detail herein.

Referring now to FIG. 4D, an example wiring arrangement to communicatively couple the control module 32 to a boost and pressure gauge 350 of the plurality of instrument gauges 24 is schematically depicted. As depicted, the control module 32 is communicatively coupled to the data communication cable 34, which may be coupled to the vehicle 12 via either the aftermarket ECU 26 or the communication port 28. The control module 32 is powered by 12V switched power 304 and ground 306. In some embodiments, the dash light power 308 may also be communicatively coupled to the control module 32. The control module 32 is configured to receive data from the vehicle through the data communication cable 34.

In some embodiments, if data is not received through the data communication cable 34 either because the vehicle 12 is not communicating or the data is not provided by the aftermarket ECU 26 or the vehicle CAN BUS communication 27, in the depicted embodiment, the boost/pressure sensor 143 may be communicatively coupled an input sender auxiliary connection portion 352 of the hardware 38 of the control module 32 via direct wiring into the hardware 38 of the control module 32. Further, the boost and pressure gauge 350 may be coupled to a connector 354, which may be communicatively coupled to the hardware 38 of the control module 32 via a switched power connection 356, a dash light power connection 358, a chassis ground connection 360, and a signal connection 362 to an auxiliary connector portion 364 of the hardware 38 of the control module 32. As such, the control module 32 may provide and receive data and signals from the boost and pressure gauge 350 via the data communication cable 34 or the directly wired connections including, without limitation, power to the boost and pressure gauge 350, dash lights to the boost and pressure gauge 350, and input commands to control the boost and pressure gauge 350, such as moving a needle, as discussed in greater detail herein.

Referring now to FIG. 4E, an example wiring arrangement to communicatively couple the control module 32 to each of the plurality of instrument gauges 24 present in the vehicle 12 is schematically depicted. As depicted, the control module 32 is communicatively coupled to the data communication cable 34, which may be coupled to the vehicle 12 via either the aftermarket ECU 26 or the communication port 28. The control module 32 is powered by 12V switched power 304 and ground 306. In some embodiments, a dash light power 308 may also be communicatively coupled to the control module 32. The control module 32 is configured to receive data from the vehicle through the data communication cable 34.

Further, in the depicted embodiment, various gauge harness wires 365 are directly coupled to the hardware 38 of the control module 32 to releasably couple the various gauge harness wires 365 to the control module 32. In the depicted embodiment, an oil pressure signal harness wire 366 is communicatively coupled to an oil receiver portion 368 of the control module 32. A temperature signal harness wire 370 is communicatively coupled to a temperature receiver portion 372 of the control module 32. A fuel level signal harness wire 374 is communicatively coupled to a fuel level receiver portion 376 of the control module 32. A tachometer signal harness wire 378 is communicatively coupled to a tachometer receiver portion 380 of the control module 32. A speedometer signal harness wire 382 is communicatively coupled to a speedometer receiver portion 384 of the control module 32. Further, a ground wire 386, a switched power wire 388 and a dash light power 390 are communicatively coupled to the control module 32. It should be appreciated that the control module 32 supports speedometer gauge, tachometer gauge, fuel level gauge, oil pressure gauge, water temperature gauge, volt gauge and further includes two auxiliary gauges (e.g. examples boost, air/fuel ratio, oil temperature, transmission temperature, pyrometer, and the like).

In some embodiments, if data is not received through the data communication cable 34 either because the vehicle 12 is not communicating or the data is not provided by the aftermarket ECU 26 or the vehicle CAN BUS communication 27, as discussed in greater detail above, the control module 32 may be communicatively coupled to a respective sender to receive data and to provide or transmit data to the plurality of instrument gauges 24. As such, the control module 32 may provide to and receive data and signals from each of the plurality of instrument gauges 24 via the data communication cable 34 or the various gauge harness wires 365, as discussed in greater detail herein.

Referring now to FIG. 5, which depicts a flow diagram that graphically depicts an illustrative method 500 for an operation of the control module to drive a plurality of instrument gauges is provided. Although the steps associated with the blocks of FIG. 5 will be described as being separate tasks, in other embodiments, the blocks may be combined or omitted. Further, while the steps associated with the blocks of FIG. 5 will described as being performed in a particular order, in other embodiments, the steps may be performed in a different order and may be continuously performed or performed at discrete intervals. Further, the steps associated with the blocks of FIG. 5 may be simultaneously performed with, in combination with, or independent from the other processes associated with FIG. 6.

At block 502, a power is communicatively coupled to the control module and at block 504, a ground is communicatively coupled to the control module. This may be an external power supply or a power supply of the vehicle. Optionally, at block 506, a dash light connector is communicatively coupled to the control module. Such a connection allows for the control module to provide commands to change, dim, illuminate, or the like, various dash lights for each of the plurality of instrument gauges present within the vehicle, as discussed in greater detail herein. At block 508, the data communication cable is communicatively coupled between the control module and the vehicle. For example, the data communication cable may be communicatively coupled to the aftermarket ECU or the vehicle CAN BUS communication via the communication port.

In embodiments, where the vehicle is not directly providing desired data or action with respect to any of the plurality of instrument gauges (e.g., via the vehicle ECU or the CAN BUS communication), then optionally each of the instrument gauges and/or sender devices may be directly wired to the control module bypassing the data communication cable, as illustrated in blocks 510-522. For example, at block 510, the speedometer gauge may be communicatively coupled to the control module and/or the speed sender may be communicatively coupled to the control module at block 512, and as illustrated in FIG. 4A. In addition to, or alternatively, the signal generator, the vehicle speed sensor, and/or the computer speed signal may also be communicatively coupled to the control module. At block 514, the fuel gauge, the temperature gauge, the oil pressure gauge, and/or the voltage gauge may be communicatively coupled to the control module and/or an associated sender (e.g., fuel sender, oil pressure sender, temperature sender, and/or the like) may be communicatively coupled to the control module at block 516, as depicted in FIG. 4B. At block 518, the tachometer gauge may be communicatively coupled to the control module. In addition to, or alternatively, the coil and the computer tach signal may be communicatively coupled to the control module, as depicted in FIG. 4C. At block 520, the boost and/or pressure gauge may be communicatively coupled to the control module. In addition to, or alternatively, the boost/pressure sensor may be communicatively coupled to the control module, as depicted in FIG. 4D. Further, it should be understood that in each of the blocks 510-522, the gauge harness for any of the instrument gauges present in the vehicle may be communicatively coupled to the control module, at block 522. It should also be understood that any of the optional blocks 510-522 may be independently incorporated into the illustrative method 500 and/or none of the optional blocks 510-522 may be utilized.

At block 524, a mobile device is synced with the control module. The mobile device may be a smart phone, tablet, personal computer, and the like. Further, the mobile device may be synced with the control module via Bluetooth®. However, this is non-limiting and other communication protocols may be utilized. At block 526, the control module queries a vehicle to determine a plurality of parameters associated with the vehicle and that may be used as inputs for the plurality of instrument gauges. Example parameters may include, without limitation, a coolant temperature, a tachometer, an oil temperature, a stock eliminator temperature, a cylinder head temperature, an exhaust gas temperature/pyrometer temperature, a transmission temperature, a fuel pressure, a fuel, or an air/fuel ratio.

At block 528, a determination is made by the control module to the type of instrument gauges present. For example, in one embodiment, the vehicle may include a speedometer gauge, a tachometer gauge, and an oil pressure gauge. In other embodiment, the vehicle may include a speedometer, a voltage gauge, and a temperature gauge. It should be appreciated that the control module supports speedometer gauge, tachometer gauge, fuel level gauge, oil pressure gauge, water temperature gauge, volt gauge and further includes two auxiliary gauges (e.g. examples boost, air/fuel ratio, oil temperature, transmission temperature, pyrometer, and the like).

At block 530, the control module outputs or transmits a plurality of data to the mobile device. The plurality of data may include, without limitation, the plurality of parameters associated with the vehicle and that may be used as inputs for the plurality of instrument gauges, the type of instrument gauges present in the vehicle, the type of command input for each of the plurality of gauge instruments present and a plurality of display data.

At block 532, the control module receives at least one diagnostic command from the mobile device. The least one diagnostic command may be a command to provide a signal to the targeted instrument gauge of the plurality of instrument gauges such as perform a calibration check, perform a sweep test of the needle, reset the instrument gauge, and/or the like. As such, when the control module receives the at least one diagnostic command, in response, at block 534, the control module uses the determined input to provide a predetermined control signal to the targeted instrument gauge of the plurality of instrument gauges to perform some action for the purposes of determining whether the target gauge performs a desirable or undesirable action. As such, it is possible for the control module to check functionality, troubleshot errors, and perform diagnosis on each one of the plurality of instrument gauges. In response, at block 536, the targeted instrument gauge of the plurality of instrument gauges provides a real-time output, which is transmitted to the mobile device to display the result of the control signal as a new verified data.

Referring now to FIG. 6, which depicts a flow diagram that graphically depicts an illustrative method 600 for an operation of the application of the mobile device to drive the plurality of instrument gauges is provided. Although the steps associated with the blocks of FIG. 6 will be described as being separate tasks, in other embodiments, the blocks may be combined or omitted. Further, while the steps associated with the blocks of FIG. 6 will be described as being performed in a particular order, in other embodiments, the steps may be performed in a different order and may be continuously performed or performed at discrete intervals. Further, the steps associated with the blocks of FIG. 6 may be simultaneously performed with, in combination with, or independent from the other processes associated with FIG. 5.

At block 524, the mobile device is synced with the control module. The mobile device may be a smart phone, tablet, personal computer, and the like. Further, the mobile device may be synced with the control module via Bluetooth®. However, this is non-limiting and other communication protocols may be utilized. At block 601, the mobile device receives a plurality of data from the control module. The plurality of data from the control module may include, without limitation, a plurality of display data, the plurality of display data includes the plurality of parameters, the type of instrument gauges of the plurality of instrument gauges present, and the type of command input for each of the plurality of gauge instruments present. It should be understood that the plurality of data may be transmitted by the control module at block 530 in FIG. 5.

At block 602, the mobile device displays virtual gauges that correspond to the plurality of instrument gauges determined to be present in the vehicle. Optionally, a plurality of virtual gauges may be displayed and the user may choose which gauges to utilize within the application. At block 604, a plurality of selections are displayed for the user based on and associated with the plurality of instrument gauges present within the vehicle or selected as virtual gauges within the application. Example selections include, without limitation, an input source selection for the speed signal and maximum speed of speedometer gauge, input source for tachometer and maximum RPM for tachometer gauge, resistance range for fuel sender unit and whether the needle of the fuel gauge moves a quarter circle or full circle from full to empty, input source for temperature signal and whether the needle of the temperature gauge moves a quarter circle or full circle from minimum temperature to maximum temperature, whether the needle of the voltage gauge moves a quarter circle or full circle from minimum voltage to maximum voltage, input source for oil pressure signal and whether the needle of the oil pressure gauge moves a quarter circle or full circle from minimum pressure to maximum pressure.

At block 606, a selection is received from the user. At block 608, a choice of instrument gauge associated with the selection may be provided for the user to select based on the selection received from the user. At block 610, the type of instrument gauge is received and based on the gauge type, at block 612, diagnostic choices are provided for the user to select. At block 614, various diagnostic choices are received from the user and in response, the mobile device transmits at least one diagnostic command to the control module, at block 616.

It should be understood that the at least one diagnostic command is received by the control module at block 532 in FIG. 5. Further, at block 618, the mobile device receives a real-time display data signal from the control module, which is transmitted from the control module at block 536 in FIG. 5.

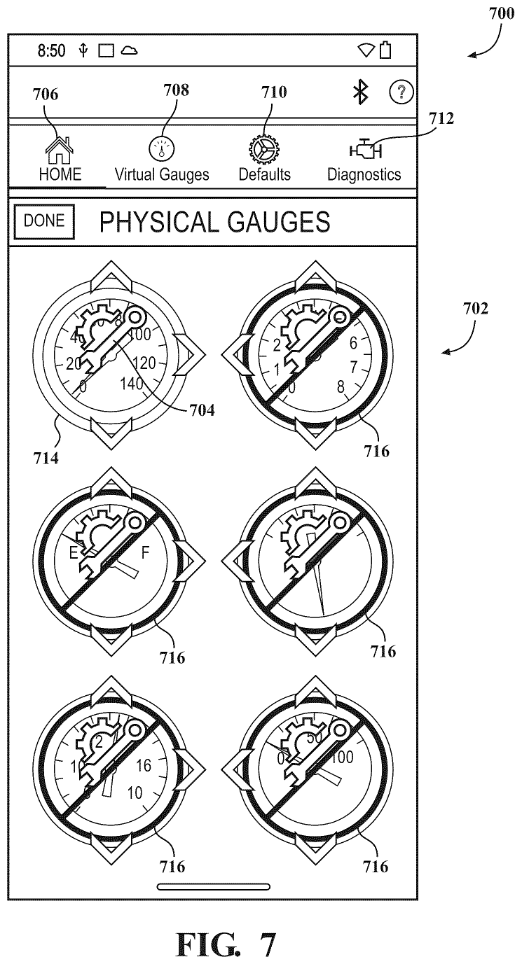

Referring back to FIG. 1 and now referring to FIG. 7, in which a plurality of virtual gauges 702 displayed by an application 700 of the mobile device 36 is schematically depicted. Each of the plurality of virtual gauges 702 are configured to respond and change in real-time in response to any commands provided by the control module 32 (FIG. 3A) to the plurality of instrument gauges 24. The plurality of virtual gauges 702 displayed mirror or mimic the determined plurality of instrument gauges 24 that are physically present in the vehicle 12. Further, the user may add virtual gauges to mirror or mimic the instrument gauges present in the vehicle by taping on a wrench button 704, which is illustrated in a non-limiting example as positioned over one of the gauge placeholders on the screen. Further displayed are shortcuts along an upper position, which include, without limitation, a home selection button 706, virtual gauges selection button 708, defaults selection button 710, and diagnostics selection button 712. As illustrated, there is currently one virtual gauge in use 714, and five instrument gauge placeholders 716. Therefore, the display may include up to six different virtual gauges in use.

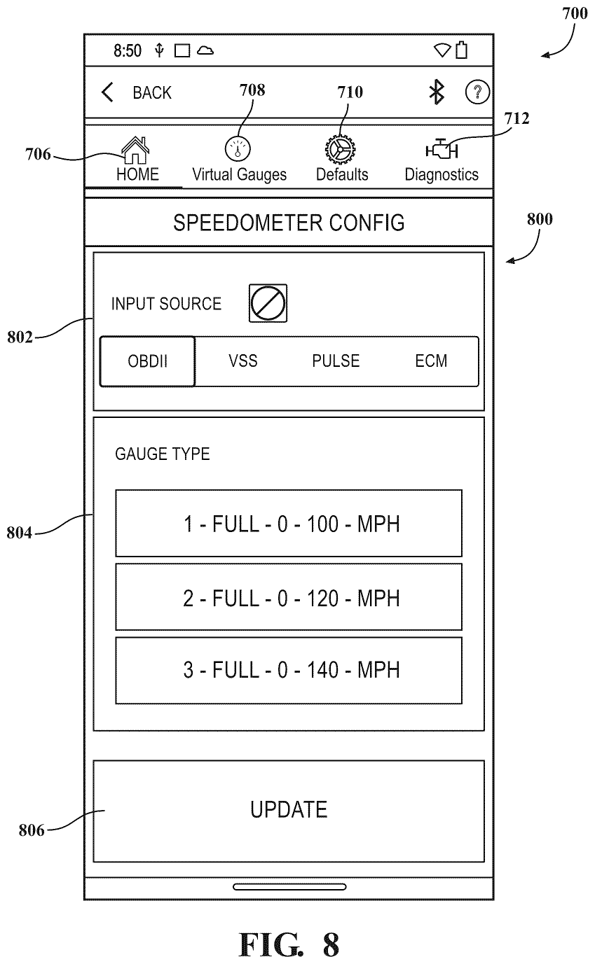

Still referring to FIG. 1 and now to FIGS. 4A and 8, in which FIG. 8 schematically depicts a speedometer gauge configuration page 800 displayed by the application 700 of the mobile device 36. The speedometer gauge configuration page 800 includes an option for an input source 802 (e.g., vehicle CAN BUS communication 27 via the communication port 28, the pulse signal generator 310, the vehicle speed sensor 312, and the computer speed signal 314. Further, the speedometer gauge configuration page 800 includes a gauge type selection window 804 for selecting a maximum speed of the speedometer gauge 302. Further, the speedometer gauge configuration page 800 includes an update button 806 or selection to store the selections.

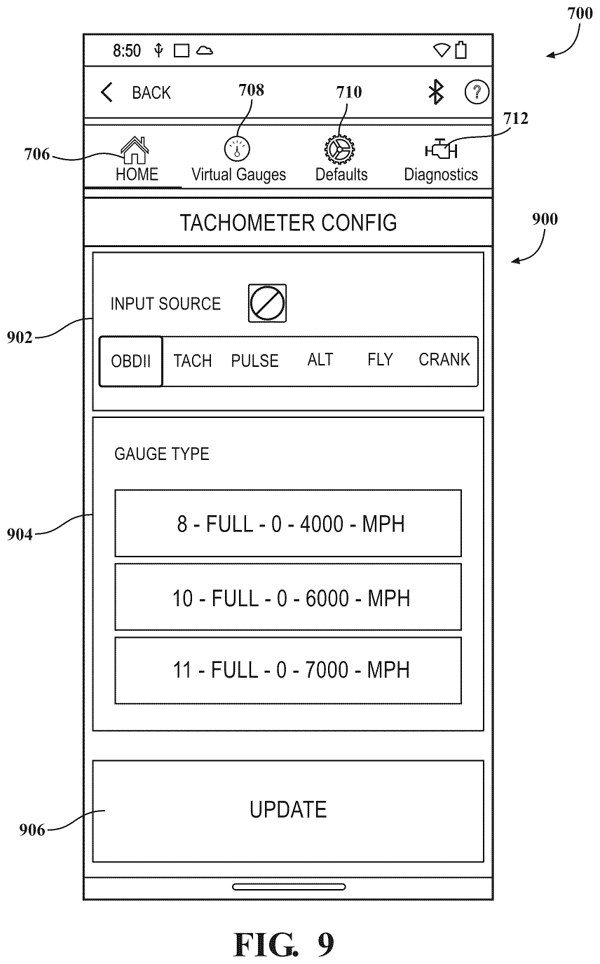

Still referring to FIG. 1 and now to FIGS. 4C and 9, in which FIG. 9 schematically depicts a tachometer gauge configuration page 900 displayed by the application 700 of the mobile device 36. The tachometer gauge configuration page 900 includes an option for an input source 902 (e.g., the vehicle CAN BUS communication 27 via the communication port 28, the pulse signal generator 310, a flywheel sender, a crankshaft sender, the computer tach signal 338, and an alternative sender). Further, the tachometer gauge configuration page 900 includes a gauge type selection window 904 for selecting a maximum revelations per minute (RPM) of the tachometer gauge 336. Further, the tachometer gauge configuration page 900 includes an update button 906 or selection to store the selections.

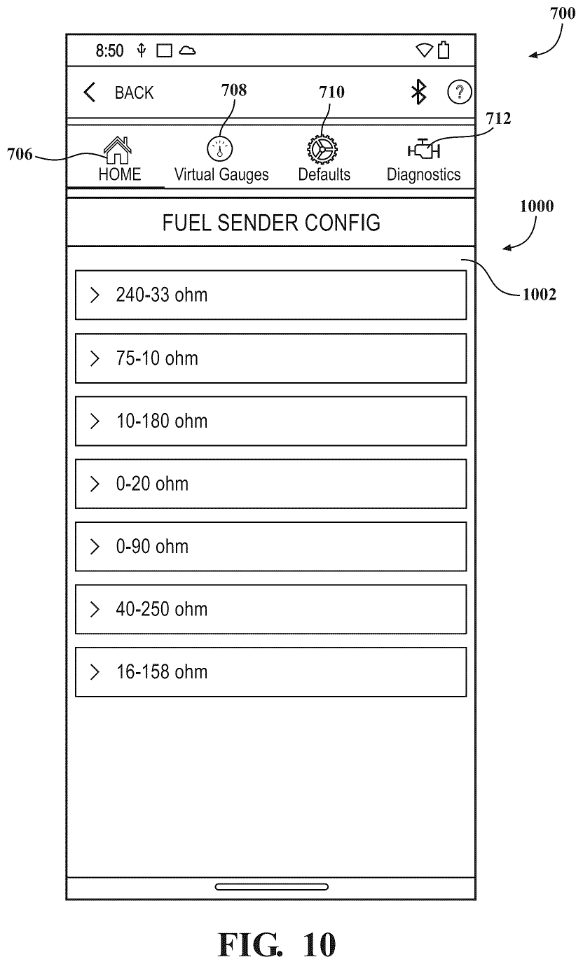

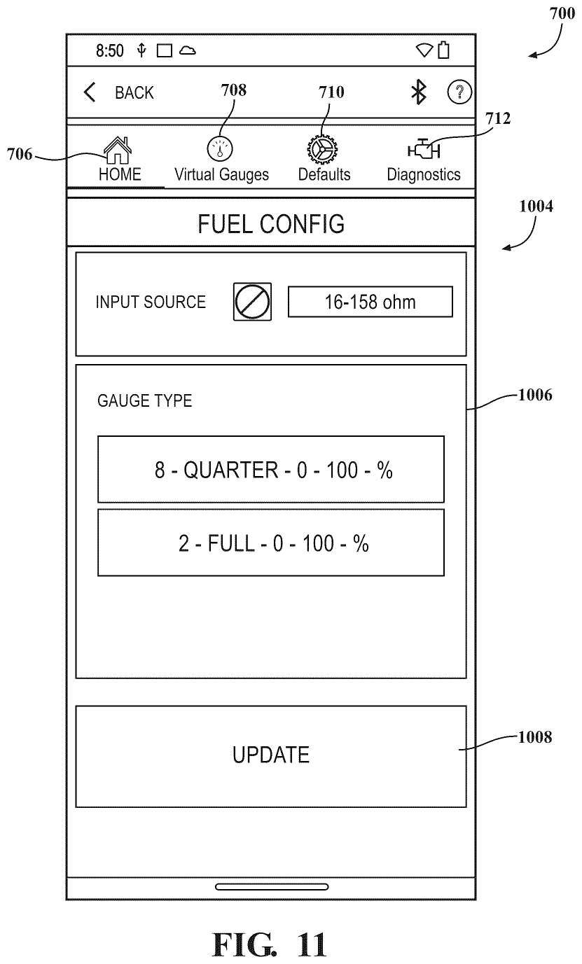

Still referring to FIG. 1 and now referring to FIG. 4B and FIG. 10, in which FIG. 10 schematically depicts a fuel sender configuration page 1000 displayed by the application 700 of the mobile device 36. The fuel sender configuration page 1000 includes a resistance range 1002 for the fuel sender device communicatively coupled to the control module 32 (FIG. 3A). FIG. 11 schematically depicts a secondary fuel sender configuration page 1004 displayed by the application 700 of the mobile device 36 following the selection of the resistance range 1002. The secondary fuel sender configuration page 1004 includes a gauge type selection 1006 in which the user selects whether a needle of the fuel gauge 324 rotates a “QUARTER” circle (from empty to full) or a three-quarter circle “FULL” (from empty to full). Further, the secondary fuel sender configuration page 1004 includes an update button 1008 or selection to store the selections.

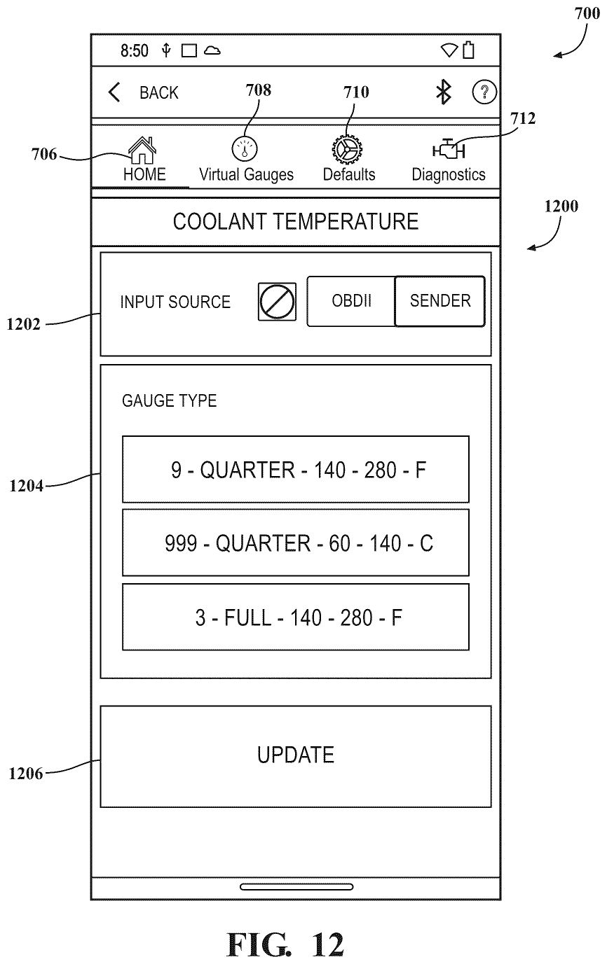

Still referring to FIGS. 1 and 4B and now referring to FIG. 12, in which FIG. 12 schematically depicts a coolant temperature page 1200 displayed by the application 700 of the mobile device 36. The coolant temperature page 1200 includes an option for an input source 1202 (e.g., the vehicle CAN BUS communication 27 via the communication port 28 or the coolant temperature sender device 124). Further, the coolant temperature page 1200 includes a gauge type selection window 1204 for selecting whether a needle of the temperature gauge 326 rotates a “QUARTER” circle (from minimum to maximum) or a three-quarter circle “FULL” (from minimum to maximum). Further, the coolant temperature page 1200 includes an update button 1206 or selection to store the selections.

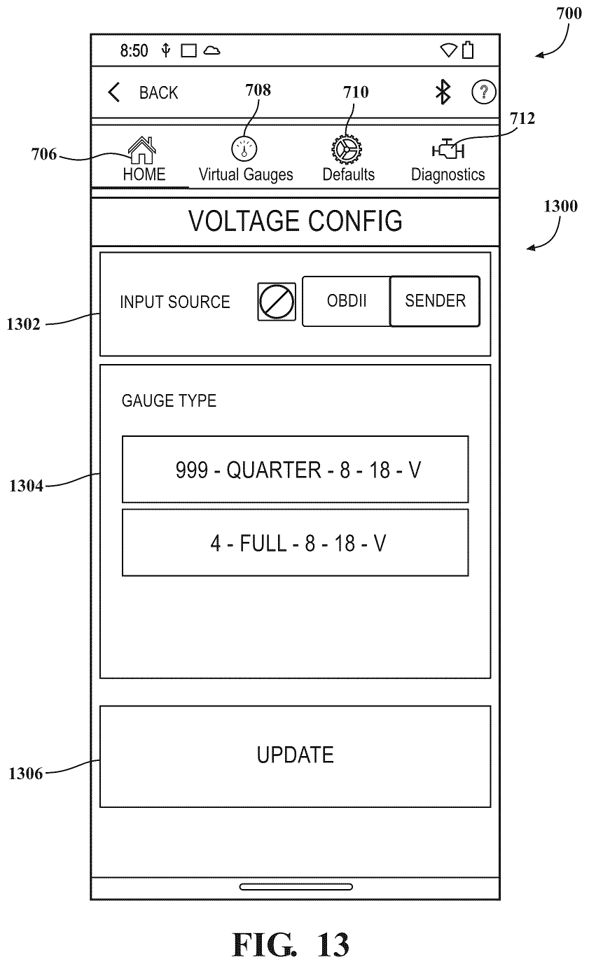

Now referring to FIG. 13, a voltage configuration page 1300 displayed by the application 700 of the mobile device 36 is schematically depicted. The voltage configuration page 1300 includes an option for an input source 1302 (e.g., the vehicle CAN BUS communication 27 via the communication port 28 or a voltage sender device). Further, the voltage configuration page 1300 includes a gauge type selection window 1304 for selecting whether a needle of the voltage gauge rotates a “QUARTER” circle (from minimum to maximum) or a three-quarter circle “FULL” (from minimum to maximum). Further, the voltage configuration page 1300 includes an update button 1306 or selection to store the selections.

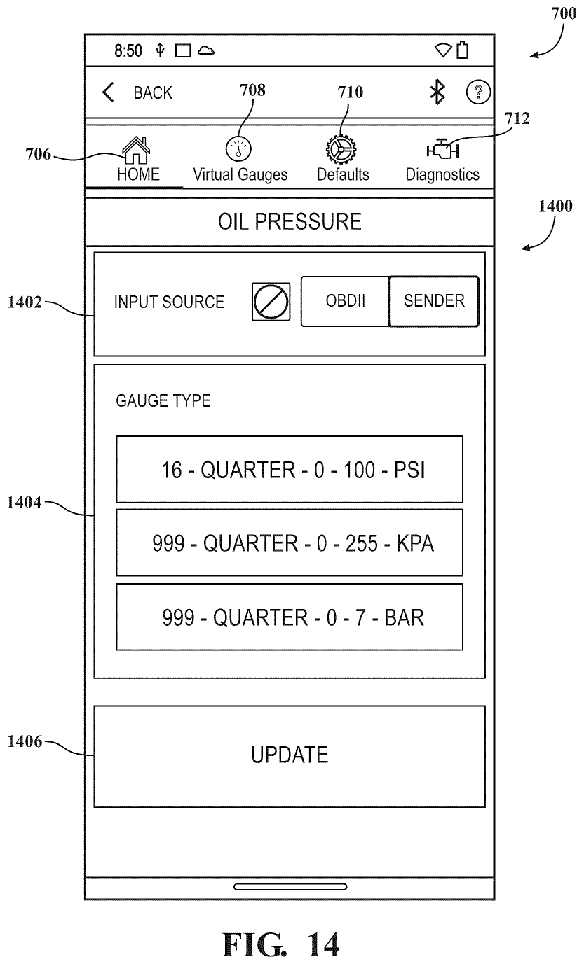

Referring back to FIGS. 1 and 4B and now referring to FIG. 14, in which FIG. 14 schematically depicts an oil pressure page 1400 displayed by the application 700 of the mobile device 36. The oil pressure page 1400 includes an option for an input source 1402 (e.g., the vehicle CAN BUS communication 27 via the communication port 28 or the oil pressure sender device 126). Further, the oil pressure page 1400 includes a gauge type selection window 1404 for selecting whether a needle of the temperature gauge 326 rotates a “QUARTER” circle (from minimum to maximum) or a three-quarter circle “FULL” (from minimum to maximum). Further, the oil pressure page 1400 includes an update button 1406 or selection to store the selections.

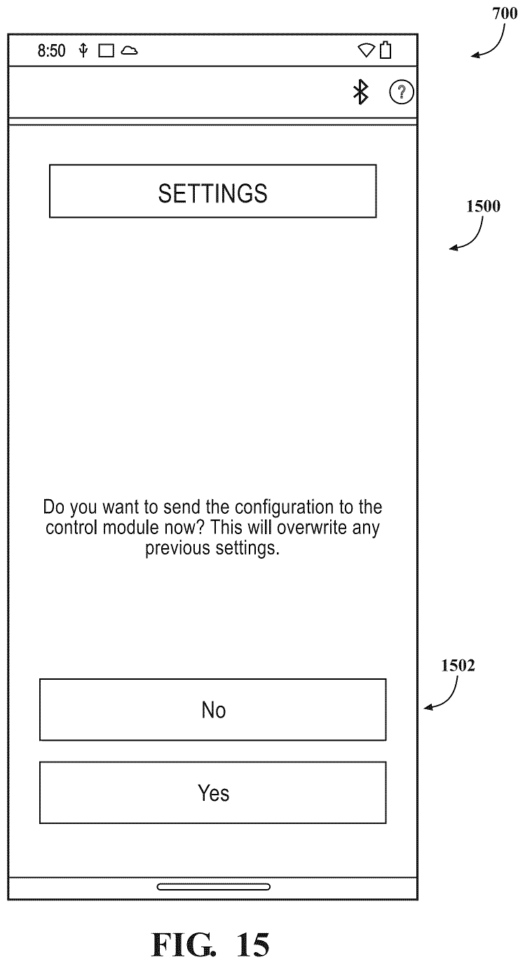

Still referring to FIG. 1 and now referring to FIG. 15, a setting page 1500 displayed by the application 700 of the mobile device 36 is schematically depicted. The setting page 1500 permits the user to accept all of the configurations for each of the plurality of instrument gauges 24 communicatively coupled to the control module 32 (FIG. 3A). The setting page 1500 provides a setting confirmation window 1502 for the user to accept or reject any recent changes to overwrite previous saved selections in the control module 32 (FIG. 3A).

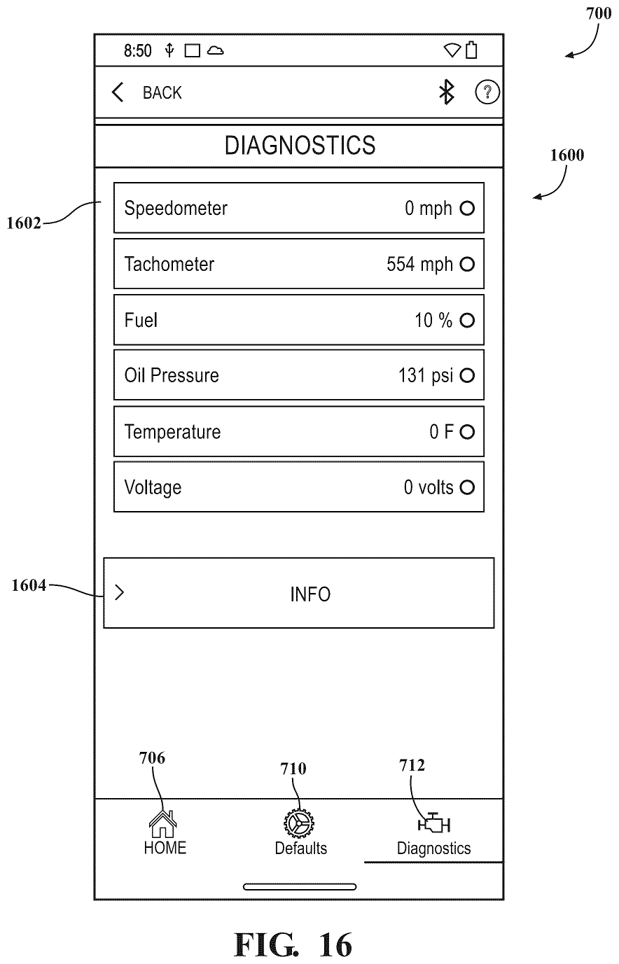

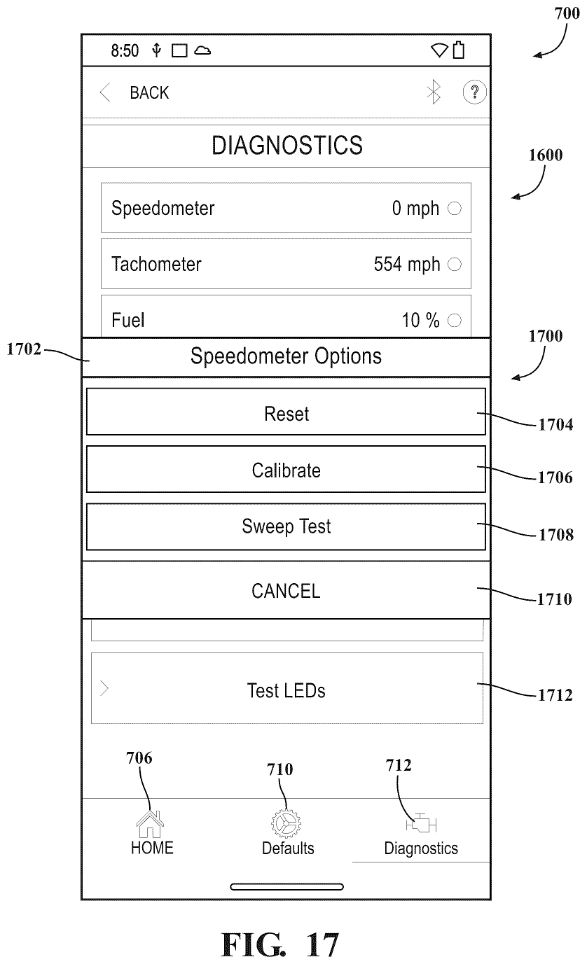

Still referring to FIG. 1 and now referring to FIG. 16, a diagnostic page 1600 displayed by the application 700 of the mobile device 36 is schematically depicted. The diagnostic page 1600 provides a visual inspection window 1602 for each of the plurality of instrument gauges 24 communicatively coupled to the control module 32 (FIG. 3A). Further, each of the plurality of instrument gauges 24 displayed in the visual inspection window 1602 may be drilled down by selecting that gauge and/or an info selection button 1604, to a plurality of diagnostic options specifically for the gauge selection, depicted best in FIG. 17. As such, in FIG. 17, a speedometer gauge diagnostics page 1700 displayed by the application 700 of the mobile device 36 is schematically depicted. In this example, the speedometer gauge diagnostics page 1700 displays a speedometer options window 1702 with various diagnostic tools. In the depicted example, the speedometer options window 1702 allows the user to select a reset selection 1704, calibrate selection 1706, sweep test selection 1708, and a cancel selection 1710. Upon activation by one of the selections (e.g., reset selection 1704, calibrate selection 1706, sweep test selection 1708) the diagnostic choice is transmitted to the control module 32 for an action to be performed by the control module and the corresponding instrument gauge, as discussed in greater detail herein. Further, a test LED selection 1712 button maybe utilized to test lighting and other instrument functionality using LEDS.

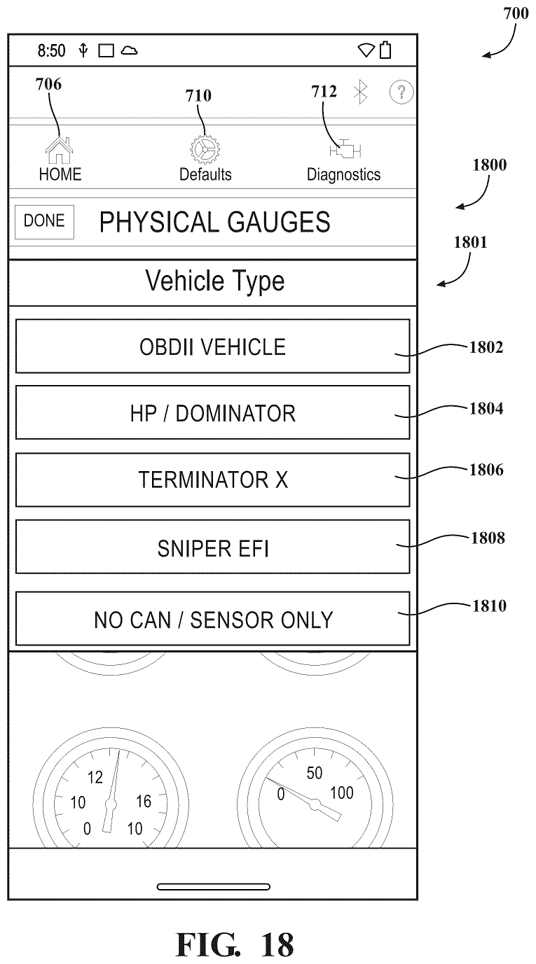

Still referring to FIG. 1 and now referring to FIG. 18, an input selection type page 1800 displayed by the application 700 of the mobile device 36 is schematically depicted. The input selection type page 1800 displays an input source selection window 1801 with various choices for how to send/receive data from the vehicle 12. In the depicted example, the input source selection window 1801 allows the user to select an OBDII vehicle selection 1802 (e.g., via the vehicle CAN BUS communication 27, various aftermarket ECU 26, such as an HP/Dominator selection 1804, Terminator X selection 1806, and Sniper EFI 1808, and a selection for sender devices only 1810.

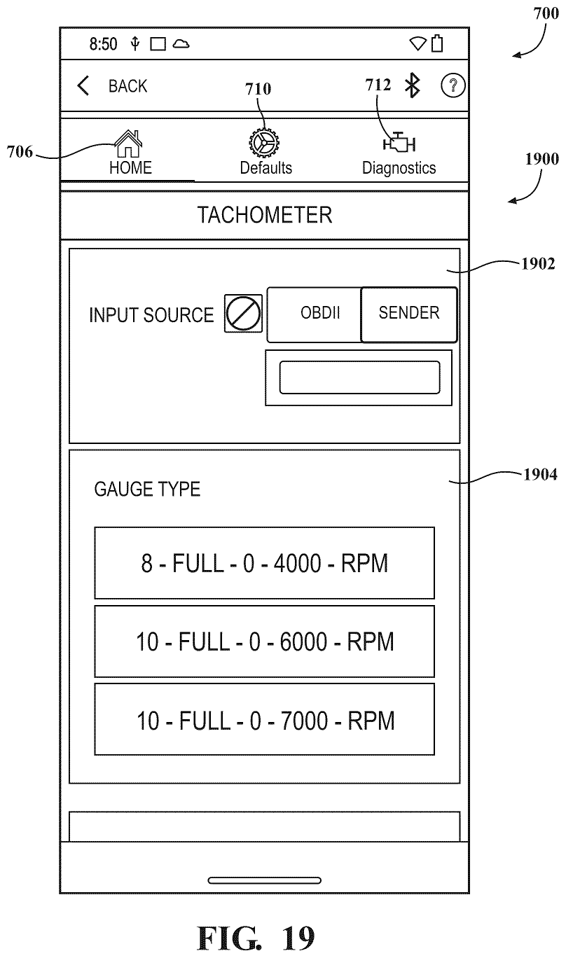

Still referring to FIG. 1 and now to FIGS. 4C and 19, in which FIG. 19 schematically depicts a tachometer gauge page 1900 displayed by the application 700 of the mobile device 36. The tachometer gauge page 1900 includes an option for an input source 1902 (e.g., the vehicle CAN BUS communication 27 via the communication port 28, the sender device(s), and the like). Further, the tachometer gauge page 1900 includes a gauge type selection window 1904 for selecting a maximum revelations per minute (RPM) of the tachometer gauge 336.

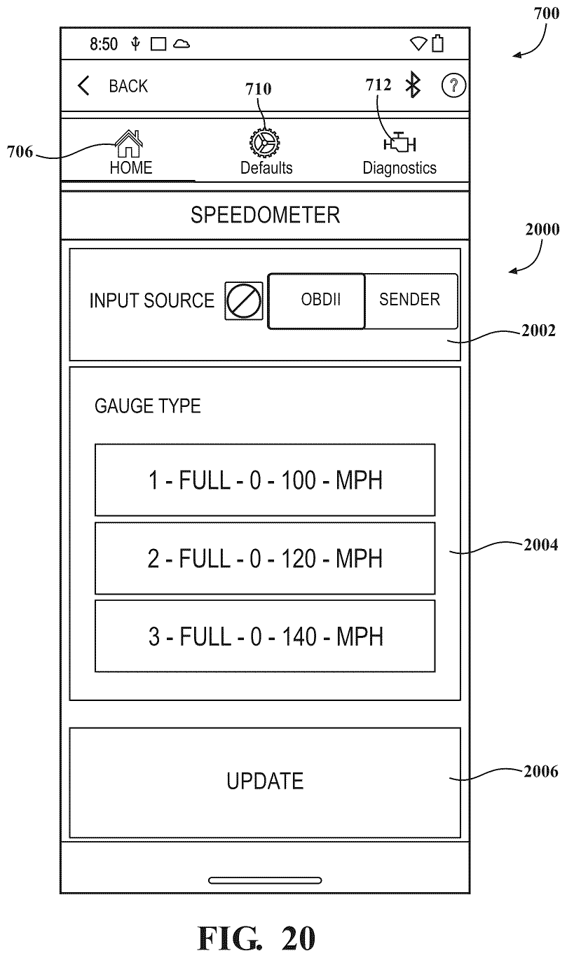

Still referring to FIG. 1 and now to FIGS. 4A and 20, in which FIG. 20 schematically depicts a speedometer gauge page 2000 displayed by the application 700 of the mobile device 36. The speedometer gauge page 2000 includes an option for an input source 2002 (e.g., vehicle CAN BUS communication 27 via the communication port 28, sender device(s), and the like). Further, the speedometer gauge page 2000 includes a gauge type selection window 2004 for selecting a maximum speed of the speedometer gauge 302. Further, the speedometer gauge page 2000 includes an update button 2006 or selection to store the selections.

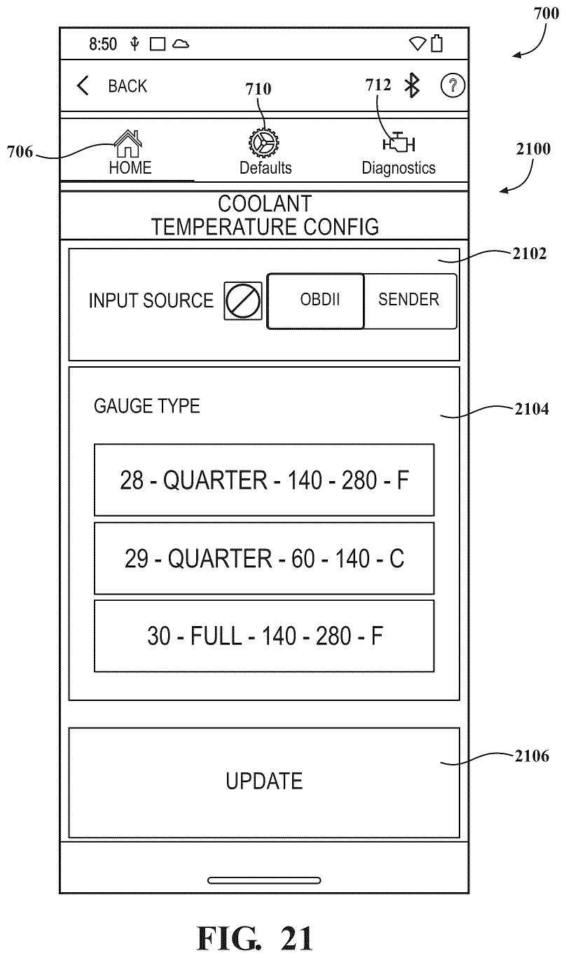

Still referring to FIG. 1 and now to 4B and now referring to FIG. 21, in which FIG. 21 schematically depicts a coolant temperature configuration page 2100 displayed by the application 700 of the mobile device 36. The coolant temperature configuration page 2100 includes an option for an input source 2102 (e.g., the vehicle CAN BUS communication 27 via the communication port 28 or the coolant temperature sender device 124). Further, the coolant temperature configuration page 2100 includes a gauge type selection window 2104 for selecting whether a needle of the temperature gauge 326 rotates a “QUARTER” circle (from minimum to maximum) or a three-quarter circle “FULL” (from minimum to maximum). Further, the coolant temperature configuration page 2100 includes an update button 2106 or selection to store the selections.

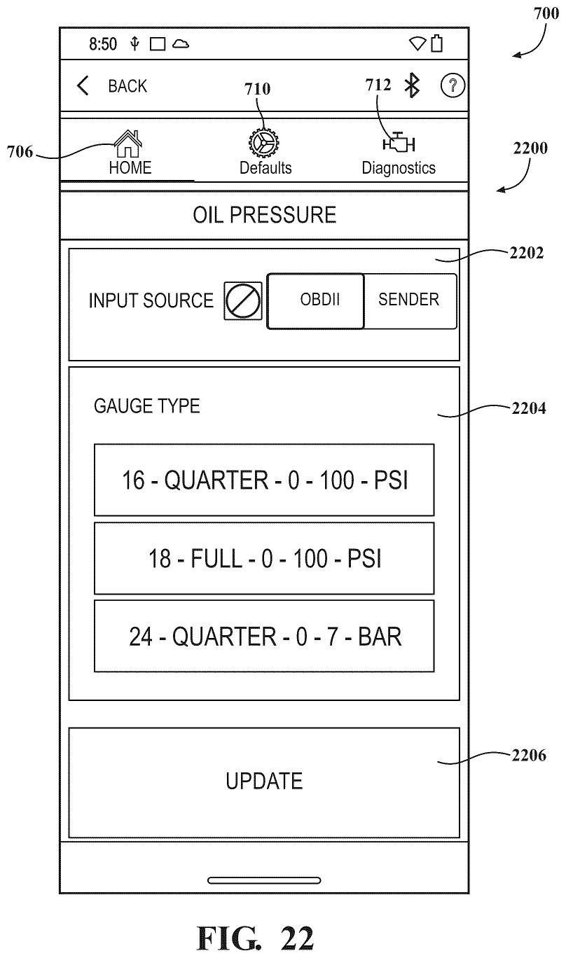

Still to FIGS. 1 and 4B and now referring to FIG. 22, in which FIG. 22 schematically depicts an oil pressure page 2200 displayed by the application 700 of the mobile device 36. The oil pressure page 2200 includes an option for an input source 2202 (e.g., the vehicle CAN BUS communication 27 via the communication port 28 or the oil pressure sender device 126). Further, the oil pressure page 2200 includes a gauge type selection window 2204 for selecting whether a needle of the temperature gauge 326 rotates a “QUARTER” circle (from minimum to maximum) or a three-quarter circle “FULL” (from minimum to maximum). Further, the oil pressure page 2200 includes an update button 2206 or selection to store the selections.

It should now be understood that the systems and methods described herein are generally directed to a vehicle diagnostic communication system for a plurality of instrument gauges of a vehicle. The plurality of instrument gauges include any classic instruments that are analog in a display output to a driver. The control module is configured to determine which instrument gauges are present in the vehicle and which parameters may be obtained from the vehicle and used as inputs to each gauges. For example, each of the instrument gauges may be actuated or driven through proper sender devices when the vehicle does not support an output the driver wants to monitor. As such, the control module determines these parameters and permits a user to use the sender inputs, the aftermarket ECU, or the communication port to generate input signals to each of the determined plurality of gauge instruments present in the vehicle.

A user is able to actuate from a mobile device a plurality of commands, which are executed through the control module for ensuring proper functionality of each of the plurality of instrument gauges, predetermined sweep to verify all functions, allow the user to cycle each of the instrument gauges to predetermined positions to verify correct outputs and wiring, and data may be sent to the control module via all serial data, all sender devices, or a combination thereof.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A communication system for a plurality of instrument gauges of a vehicle, the communication system comprising:
a control module communicatively coupled to the vehicle and configured to:
query the vehicle to determine a plurality of parameters associated with the vehicle to use as inputs for the plurality of instrument gauges;
determine which type of instrument gauges of the plurality of instrument gauges are present in the vehicle;
determine a type of command input provided by the vehicle and received by each instrument gauge of the plurality of instrument gauges;
output a plurality of display data, the plurality of display data includes the plurality of parameters, the type of instrument gauges of the plurality of instrument gauges present, and the type of command input for each of the plurality of gauge instruments present;
receive a diagnostic command for type of the instrument gauge,
in response to receiving the diagnostic command, provide a command data to the corresponding instrument gauge of the plurality of instrument gauges of the vehicle via the determined type of command input, the command data causes the corresponding instrument gauge to receive a programming instruction, perform a sweep test to determine functionality, or perform a cycle of the corresponding instrument gauge.

2. The communication system of claim 1, further comprising:
a data communication cable communicatively coupled to the vehicle and the control module and configured to receive and transmit a plurality of data between the vehicle and the control module.

3. The communication system of claim 2, wherein the vehicle further comprises:
an electronic control unit communicatively coupled to the plurality of instrument gauges;
a communication port communicatively coupled to the plurality of instrument gauges; and
a plurality of sender devices communicatively coupled to the plurality of instrument gauges.

4. The communication system of claim 3, wherein the data communication cable is directly coupled to the electronic control unit or the communication port.

5. The communication system of claim 3, wherein the communication port is for a vehicle CAN BUS communication.

6. The communication system of claim 3, wherein the determination of the type of command input provided by the vehicle is to provide the command data through a corresponding input used by the vehicle.

7. The communication system of claim 1, wherein the type of instrument gauges of the plurality of instrument gauges present is selected from at least one of a speedometer gauge, a tachometer gauge, a fuel level gauge, an oil pressure gauge, a water temperature gauge, a voltmeter gauge, a boost gauge, an air/fuel ratio gauge, an oil temperature gauge, a transmission temperature gauge, and a pyrometer gauge.

8. The communication system of claim 1, wherein the plurality of parameters associated with the vehicle to use as inputs for the plurality of instrument gauges is selected from at least one of a coolant temperature, a tachometer, an oil temperature, a stock eliminator temperature, a cylinder head temperature, an exhaust gas temperature/pyrometer temperature, a transmission temperature, a fuel pressure, a fuel, or an air/fuel ratio.

9. The communication system of claim 1, wherein the diagnostic command for the type of the instrument gauge received is from a mobile device communicatively coupled to the control module.

10. The communication system of claim 9, wherein the mobile device is configured to:
receive the plurality of display data;
display a virtual gauge for each of the plurality of instrument gauges in the vehicle;
receive a selection for an input source associated with one or more of the virtual gauge;
provide a choice of gauge types that correspond to the selections of the virtual gauge;
receive a diagnostic choice for the type of instrument gauges;
provide the diagnostic command to the control module for the corresponding instrument gauge of the plurality of instrument gauges of the vehicle; and
in response, display real time data received from the corresponding instrument gauge of the plurality of instrument gauges of the vehicle following the initiating of the diagnostic command.

11. A method for driving a plurality of instrument gauges of a vehicle, the method comprising:
querying, by a control module, the vehicle to determine a plurality of parameters associated with the vehicle to use as inputs for the plurality of instrument gauges;
determining, by the control module, which type of instrument gauges of the plurality of instrument gauges are present in the vehicle;
determining, by the control module, a type of command input provided by the vehicle and received by each instrument gauge of the plurality of instrument gauges;
outputting, by the control module, a plurality of display data, the plurality of display data includes the plurality of parameters, the type of instrument gauges of the plurality of instrument gauges present, and the type of command input for each of the plurality of gauge instruments present;
receiving, by a mobile device, the plurality of display data;
displaying, by the mobile device, a virtual gauge for each of the plurality of instrument gauges present in the vehicle;
receiving, by the mobile device, a selection for an input source associated with one or more of the virtual gauge;
receiving, by the mobile device, a diagnostic choice for the type of instrument gauges;
transmitting, by the mobile device, a diagnostic command to the control module for the corresponding instrument gauge of the plurality of instrument gauges of the vehicle; and
in response to receiving the diagnostic command, providing, by the control module, a command data to the corresponding instrument gauge of the plurality of instrument gauges of the vehicle via the determined type of command input, the command data causes the corresponding instrument gauge to receive a programming instruction, perform a sweep test to determine functionality, or perform a cycle of the corresponding instrument gauge.

12. The method of claim 11, further comprising:
in response to the providing the command data to the corresponding instrument gauge of the plurality of instrument gauges of the vehicle, displaying, by the mobile device, a real time data received from the corresponding instrument gauge of the plurality of instrument gauges of the vehicle.

13. The method of claim 11, wherein the control module is communicatively coupled to the vehicle via a data communication cable configured to receive and transmit a plurality of data between the vehicle and the control module.

14. The method of claim 13, wherein the vehicle further comprises:
an electronic control unit communicatively coupled to the plurality of instrument gauges;
a communication port communicatively coupled to the plurality of instrument gauges; and
a plurality of sender devices communicatively coupled to the plurality of instrument gauges.

15. The method of claim 14, wherein the data communication cable is directly coupled to the electronic control unit or the communication port and to the control module.

16. The method of claim 11, wherein the determination of the type of command input provided by the vehicle is to provide the command data through a corresponding input used by the vehicle.

17. The method of claim 11, wherein the type of instrument gauges of the plurality of instrument gauges present is selected from at least one of a speedometer gauge, a tachometer gauge, a fuel level gauge, an oil pressure gauge, a water temperature gauge, a voltmeter gauge, a boost gauge, an air/fuel ratio gauge, an oil temperature gauge, a transmission temperature gauge, and a pyrometer gauge.

18. The method of claim 11, wherein the plurality of parameters associated with the vehicle to use as inputs for the plurality of instrument gauges is selected from at least one of a coolant temperature, a tachometer, an oil temperature, a stock eliminator temperature, a cylinder head temperature, an exhaust gas temperature/pyrometer temperature, a transmission temperature, a fuel pressure, a fuel, or an air/fuel ratio.
